(19) United States
(12) Patent Application Publication
(10) Pub. No.: US 2024/0214936 A1
(43) Pub. Date: Jun. 27, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Yongyang DU, Dongguan (CN); Lei HUANG, Singapore (SG); Liuming LU, Dongguan (CN); Chaoming LUO, Dongguan (CN); Ronghui HOU, Dongguan (CN)

(73) Assignee: GUANGDONG OPPO MOBILE TELECOMMUNICATIONS CORP., LTD., Dongguan (CN)

(21) Appl. No.: 18/598,966

(22) Filed: Mar. 7, 2024

Related U.S. Application Data
(63) Continuation of application No. PCT/CN2021/117541, filed on Sep. 9, 2021.

(51) Int. Cl. H04W 52/02; H04W 60/04; H04W 76/20

(52) U.S. Cl. CPC H04W 52/0235; H04W 60/04; H04W 76/20

(57) ABSTRACT

The present application provides a wireless communication method and a device. The method includes: a first AP affiliated with an AP MLD transmitting a first message over a first link to a first STA affiliated with a Non-AP MD, wherein the first message is configured to indicate whether a second AP affiliated with the AP MLD is in a wake-up state or an active state; and/or the first AP receives, over the first link, a second message transmitted from the first STA, wherein the second message is configured to request the second AP affiliated with the AP MLD to be in the wake state or the active state, or the second message is configured to indicate whether a second STA is in the wake state or the active state.

### CROSS REFERENCE TO RELATED APPLICATIONS

The present disclosure is a continuation-application of International (PCT) Patent Application No. PCT/CN2021/117541 filed on Sep. 9, 2021, the entire contents of which are incorporated herein by reference.

### TECHNICAL FIELD

The present disclosure relates to the field of mobile communication technologies, and in particularly to a wireless communication method and a device.

### BACKGROUND

The wireless local area network industry is currently one of the fastest growing industries in the entire data communication field. As a supplement and extension of traditional wired local area network, the wireless local area network technical solution has been rapidly applied due to its advantages of flexibility, mobility, scalability, and lower investment cost. The wireless local area network has gained favors of home network users, tiny and medium-sized office users, a vast number of enterprise users and telecommunication operators. Now more and more wireless local area network devices support soft access point (AP) function. Without deploying a dedicated AP, the Soft AP may enable a network device that supports the same function to set up a wireless network in almost any desired location with a low cost, and is especially suitable for providing a cost-effective and rapid way of networking for a few users in small offices and family environments, as well as for construction sites, exhibitions, athletic events, and other places that require a temporary network. At present, the most typical application of the Soft AP is to open a cell phone Wi-Fi hotspot for network sharing.

A Soft AP multi-link device (MLD) has a non-simultaneous transmit and receive (NSTR) link pair. One link of the NSTR link pair serves as a primary link for transmitting a Beacon Frame and a probe response frame. Another link of the NSTR link pair serves as a secondary link, which does not perform the transmission of the Beacon frame and the Probe Response frame.

In the related art, regarding energy saving for AP MLDs, the limitation brought by a relationship of the primary link and the secondary link of the AP MLD has not been considered.

### SUMMARY OF THE DISCLOSURE

The present disclosure provides a wireless communication method, and a device.

According to a first aspect, a wireless communication method is provided. The method includes: a first AP affiliated with an AP MLD transmits a first message over a first link to a first station (STA) affiliated with a non-access point multi-link device (Non-AP MLD), wherein the first message is configured to indicate whether a second AP affiliated with the AP MLD is in a wake state or an active state; and/or the first AP affiliated with the AP MLD receives, over the first link, a second message sent from the first STA affiliated with the Non-AP MLD, wherein the second message is configured to request the second AP affiliated with the AP MLD to be in the wake state or the active state, or the second message is configured to indicate whether the second STA affiliated with the Non-AP MLD is in the wake state or the active state. The first AP and the first STA are over the first link, the first link is a primary link. The second AP and the second STA are over the second link, the second link is a secondary link.

According to a second aspect, an AP MLD is provided. The AP MLD includes a processor and a memory. The memory is configured to store a computer program. The processor is configured to call and run the computer program stored in the memory, and perform a wireless communication method. The method includes: a first access point (AP) affiliated with the AP MLD transmitting a first message over a first link to a first station (STA) affiliated with a non-access point multi-link device (Non-AP MLD), wherein the first message is configured to indicate whether a second AP affiliated with the AP MLD is in a wake state or an active state; and/or the first AP affiliated with the AP MLD receiving, over the first link, a second message sent from the first STA affiliated with the Non-AP MLD, wherein the second message is configured to request the second AP affiliated with the AP MLD to be in the wake state or the active state, or the second message is configured to indicate whether a second STA affiliated with the Non-AP MLD is in the wake state or the active state. The first AP and the first STA are over the first link, the first link is a primary link. The second AP and the second STA are over a second link, and the second link is a secondary link.

According to a third aspect, a Non-AP MLD is provided. The Non-AP MLD includes a processor and a memory. The memory is configured to store a computer program. The processor is configured to call and run the computer program stored in the memory, and to perform a wireless communication method. The method includes: a first station (STA) affiliated with the Non-AP MLD receiving a first message transmitted by a first access point (AP) affiliated with an access point multi-link device (AP MLD) over a first link, wherein the first message is configured to indicate whether a second AP affiliated with the AP MLD is in a wake state or an active state; and/or the first STA affiliated with the Non-AP MLD transmitting a second message over the first link to the first AP affiliated with the AP MLD, wherein the second message is configured to request that the second AP affiliated with the AP MLD to be in the wake state or the active state, or the second message is configured to indicate whether the second STA affiliated with the Non-AP MLD is in the wake state or the active state. The first AP and the first STA are over the first link, the first link is a primary link. The second AP and the second STA are over a second link, and the second link is a secondary link.

### BRIEF DESCRIPTION OF THE DRAWINGS

The accompanying drawings illustrated herein are meant to provide a further understanding of the present disclosure and form a part hereof. The schematic embodiments of the present disclosure and the description thereof are meant to interpret the present disclosure and do not constitute an undue limitation of the present disclosure. In the drawings:

FIG. 1 is a schematic diagram of an application scenario according to an embodiment of the present disclosure.

FIG. 2 is a schematic diagram of an application scenario according to an embodiment of the present disclosure.

FIG. 3 is an optional schematic diagram of an energy-saving mode according to an embodiment of the present disclosure.

FIG. 4 is an optional schematic diagram of an energy-saving mode according to an embodiment of the present disclosure.

FIG. 5 is an optional schematic diagram of an energy-saving mode according to an embodiment of the present disclosure.

FIG. 6A is an optional schematic flowchart of a wireless communication method according to an embodiment of the present disclosure.

FIG. 6B is an optional schematic flowchart of a wireless communication method according to an embodiment of the present disclosure.

FIG. 6C is an optional schematic flowchart of a wireless communication method according to an embodiment of the present disclosure.

FIG. 6D is an optional schematic flowchart of a wireless communication method according to an embodiment of the present disclosure.

FIG. 6E is an optional schematic flowchart of a wireless communication method according to an embodiment of the present disclosure.

FIG. 7 is a schematic structural diagram of a communication system according to an embodiment of the present disclosure.

FIG. 8 is an optional timing sequence schematic diagram of a wireless communication method according to an embodiment of the present disclosure.

FIG. 9 is an optional timing sequence schematic diagram of a wireless communication method according to an embodiment of the present disclosure.

FIG. 10 is an optional timing sequence schematic diagram of a wireless communication method according to an embodiment of the present disclosure.

FIG. 11 is an optional timing sequence schematic diagram of a wireless communication method according to an embodiment of the present disclosure.

FIG. 12A is an optional timing sequence schematic diagram of a wireless communication method according to an embodiment of the present disclosure.

FIG. 12B is a schematic diagram illustrating an optional frame format of an indication element according to an embodiment of the present disclosure.

FIG. 12C is a schematic diagram illustrating an optional frame format of an action element according to an embodiment of the present disclosure.

FIG. 13 is a schematic diagram illustrating an optional frame format of a control subfield according to an embodiment of the present disclosure.

FIG. 14 is a schematic diagram illustrating an optional frame format of a control subfield according to an embodiment of the present disclosure.

FIG. 15 is a schematic diagram illustrating an optional frame format of a control subfield according to an embodiment of the present disclosure.

FIG. 16 is an optional timing sequence schematic diagram of a wireless communication method according to an embodiment of the present disclosure.

FIG. 17 is an optional timing sequence schematic diagram of a wireless communication method according to an embodiment of the present disclosure.

FIG. 18 is an optional timing sequence schematic diagram of a wireless communication method according to an embodiment of the present disclosure.

FIG. 19 is an optional timing sequence schematic diagram of a wireless communication method according to an embodiment of the present disclosure.

FIG. 20 is an optional timing sequence schematic diagram of a wireless communication method according to an embodiment of the present disclosure.

FIG. 21 is a schematic diagram illustrating an optional frame format of a control subfield according to an embodiment of the present disclosure.

FIG. 22 is an optional timing sequence schematic diagram of a wireless communication method according to an embodiment of the present disclosure.

FIG. 23 is an optional schematic structural diagram of a wireless communication apparatus according to an embodiment of the present disclosure.

FIG. 24 is an optional schematic structural diagram of a wireless communication apparatus according to an embodiment of the present disclosure.

FIG. 25 is a schematic structural diagram of a communication device provided according to an embodiment of the present disclosure.

FIG. 26 is a schematic structural diagram of a chip according to an embodiment of the present disclosure.

FIG. 27 is a schematic block diagram of a communication system according to an embodiment of the present disclosure.

### DETAILED DESCRIPTION

Technical schemes in embodiments of the present disclosure will be described in connection with accompanying drawings of the embodiments of the present disclosure. Obviously, the described embodiments are only a part of the embodiments, but not all of them. All other embodiments occur to a person of ordinary skills in the art based on embodiments of the present disclosure without creative efforts should all be within the protection scope of the present disclosure.

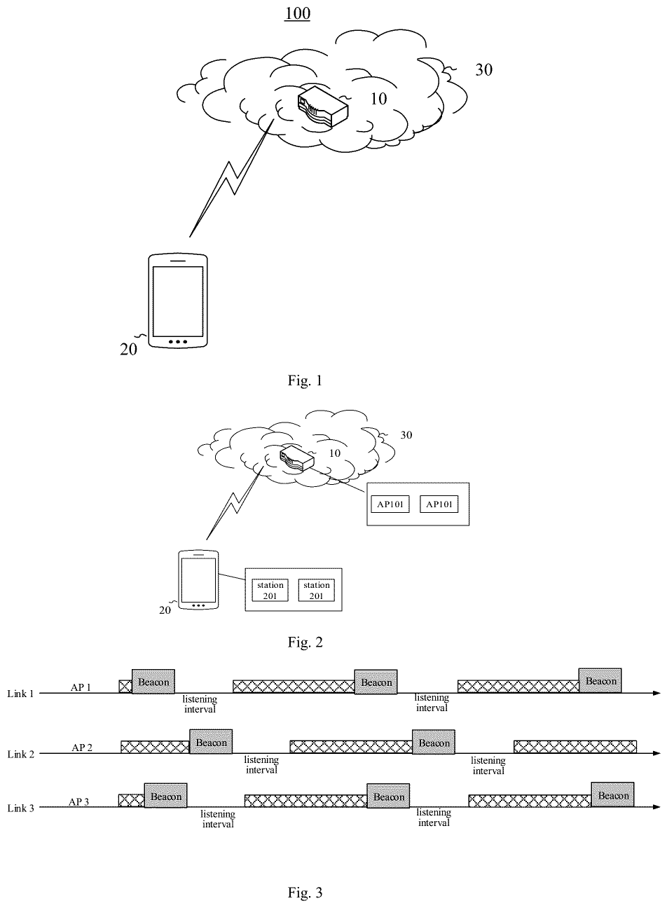

FIG. 1 is a schematic diagram of an application scenario according to an embodiment of the present disclosure.

As illustrated in FIG. 1, the communication system 100 may include an AP MLD 10 and a Non-AP MLD 20. The AP MLD 10 is an electronic device capable of creating a wireless local area network 30 based on emitted signals, and is for example a router, a cell phone with a hotspot function, etc. The Non-AP MLD 20 is an electronic device that is connected to the wireless local area network 30 created by the AP MLD 10, and is for example a cell phone, a smart washing machine, an air conditioner, an electronic lock, etc. The Non-AP MLD 20 and the AP MLD 10 perform communication through the wireless local area network 30. The AP MLD 10 may be a soft AP MLD, a Mobile AP MLD etc.

As illustrated in FIG. 2, in the communication system 100 illustrated in FIG. 1, the AP MLD 10 includes at least two affiliated AP101s, and the Non-AP MLD 20 includes at least two affiliated stations 201 (STAs). The various APs are connected to different STAs in the Non-AP MLD 20 via different links. The APs affiliated with or belonging to the AP MLD may also be referred to as the affiliated APs of the AP MLD, and the STAs affiliated with or belonging to the Non-AP MLD may also be referred to as the affiliated STAs of the Non-AP MLD.

One of the plurality of links between the AP MLD 10 and the Non-AP MLD 20 serves as a primary link and transmits a Beacon Frame and a Probe Response Frame. The links other than the primary link are secondary links (i.e., non-primary links), and do not perform a transmission of Beacon Frames and Probe Response Frames.

In embodiments of the present disclosure, the AP MLD 10 and the Non-AP MLD 20 may be terminal devices. The terminal device may refer to an access terminal, a user equipment (UE), a subscriber unit, a subscriber station, a mobile station, a mobile console, a remote station, a remote terminal, a mobile device, a subscriber terminal, a terminal, a wireless communication device, a user agent, or a subscriber apparatus. The access terminal may be a cellular telephone, a cordless telephone, a session initiation protocol (SIP) telephone, a wireless local loop (WLL) station, a personal digital assistant (PDA), a handheld device with wireless communication function, a computing device or other processing device connected to a wireless modem, an in-vehicle device, a wearable device, a terminal device of a 5th generation (5G) network, or a terminal device in a future-evolved public land mobile network (PLMN) etc.

In the communication system 100 illustrated in FIG. 1, the wireless communication system 100 may further include a network device. The network device may be an access network device that communicates with the terminal device. The access network device may provide communication coverage for a specific geographic area, and may communicate with terminal devices located within that coverage area.

The network device may be an evolutional Node B (eNB or eNodeB) in a long-term evolution (LTE) system, or a next generation radio access network (NG RAN) device, or a base station (gNB) in an NR system, or a radio controller in a cloud radio access network (CRAN). In some embodiments, the network device may be a relay station, an access point, an in-vehicle device, a wearable device, a hub, a switch, a bridge, a router, or a network device in a future-evolved public land mobile network (PLMN) etc.

In the communication system 100 illustrated in FIG. 1, the wireless communication system 100 may further include a core network device. The core network device is configured to perform communication with the base station. The core network device may be a 5G Core (5GC) device, e.g., an access and mobility management function (AMF), also e.g., an authentication server function (AUSF), e.g., a user plane function (UPF), e.g., a session management function (SMF). In some embodiments, the core network device may also be an evolved packet core (EPC) device for the LTE network, e.g., a session management function+core packet gateway (SMF+PGW-C) device. The SMF+PGW-C may fulfill the functions that either of the SMF and the PGW-C may fulfill at the same time. In the process of a network evolution, the above-mentioned core network devices may also be referred to by other names, or new network entities may be formed by dividing the functions of the core networks, on which the embodiments of the present disclosure do not impose any limitation.

FIG. 1 schematically illustrates an AP MLD and a Non-AP MLD. Alternatively, the wireless communication system 100 may include a plurality of Non-AP MLDs for accessing the wireless local area network 30, on which embodiments of the present disclosure do not impose any limitation.

FIG. 1 just schematizes the system to which the present disclosure is applicable in an exemplary form, the methods illustrated in the embodiments of the present disclosure may of course also be applicable to other systems. In addition, the terms “system” and “network” are often used interchangeably herein. The term “and/or” is merely an associating relationship for describing the associated objects, and indicates that there could be three relationships between the associated objects. For example, A and/or B may represent three situations: only A exists, A and B exist simultaneously, and only B exists. In the present disclosure, the character “/” generally indicates an “or” relationship between the associated objects before and after the character “/”. It should also be appreciated that, the expression “indication” referred to in embodiments of the present disclosure may be a direct indication, an indirect indication, or an indication of an associated relationship. For example, “A indicates B” may mean that: A directly indicates B, e.g., B may be obtained through A; A indirectly indicates B, e.g., A indicates C, and B may be obtained through C; and there is an associated relationship between A and B. It should also be appreciated that, the expression “corresponding” mentioned in the embodiments of the present disclosure may indicate a direct or indirect correspondence between two objects, or an association between the two, or a relationship of indicating and being indicated, configuring and being configured etc. It should also be appreciated that, the expression “predefined” or “predefined rules” referred to in the embodiments of the present disclosure may be realized by storing in advance, corresponding codes, forms, or other means that may be used to indicate relevant information, in a device (e.g., including a terminal device and a network device), the specific implementation of which is not limited in embodiments of the present disclosure. For example, the expression “predefined” may mean being defined in a protocol. In embodiments of the present disclosure, the term “protocol” may refer to a standard protocol in the communication field, and may include, for example, an LTE protocol, an NR protocol, and related protocols to be applied in future communication systems, on which no limitation is imposed by the present disclosure.

To facilitate understanding of the technical scheme of embodiments of the present disclosure, the relevant technologies of embodiments of the present disclosure are described below, and the following relevant technologies may be arbitrarily combined, as an optional scheme, with the technical schemes of embodiments of the present disclosure. The combined results all belong to the protection scope of embodiments of the present disclosure.

In mid-May 2021, the TGbe working group issued a Draft 1.0, concluding the first phase of 11be. The NSTR Soft AP MLD (hereinafter referred to as the Soft AP MLD) is a key technology in 11be multi-link operation. In comparison to the previous Draft versions, in the Draft 1.0, the Soft AP MLD is clearly defined and described. In the current standard, the Soft AP MLD is an AP MLD that has one NSTR link pair and has the following three typical limitations:
Soft AP MLDs are located in mobile devices and are typically powered by batteries. Today, such devices are typically represented by cell phones, tablets, laptops, etc. The “WLAN signal” function in Huawei/Honor cell phones and the “WLAN network sharing” function integrated in OPPO cell phones are typical applications of Soft AP.
The Soft AP MLD requires one link of the NSTR link pair to be designated as the primary link for transmitting the Beacon Frame and the Probe Response Frame. The other link of the NSTR link pair serves as the secondary link. In general, a conventional device and a single-link device may use the primary link to communicate with the AP MLD. The multi-link device that supports the 11be may use both the primary link and the secondary link to communicate with the AP MLD.
When an AP of the Soft AP MLD (or an STA of the Non-AP MLD associated to the AP MLD) intends to initiate a PHY protocol data unit (PPDU) transmission on the secondary link, other affiliated APs (or other affiliated STAs) of the same MLD are required to initiate a PPDU transmission on the primary link as a role of a transmission opportunity (TXOP) holder at the same beginning time. This rule is a transmission restriction concerning the NSTR Soft AP MLDs. By this restriction, an MLD that intends to use the secondary link must also get the TXOP of the primary link, thereby avoiding a situation in which one link of the NSTR link pair performs a downlink reception while the other link of the NSTR link pair performs an uplink transmission. In this way, an incidence of conflict is reduced.

Since the Soft AP MLDs are powered by batteries, the energy-saving requirements of Soft AP MLDs are rendered particularly prominent, especially due to increased energy consumption resulting from usage of multi-links. How to develop a feasible energy-saving scheme under the existing Soft AP MLD restriction has become an urgent problem.

In the related art, for the Soft AP MLD, the following three energy-saving approaches are proposed: an energy-saving approach A1, implicit listening interval; an energy-saving approach A2, energy is saved based on target wake time (TWT); and an energy-saving approach A3, energy is saved based on the primary link.

In the energy-saving approach A1, as illustrated in FIG. 3, the affiliated AP of the Soft AP MLD is waked to transmit the beacon frame, and then remains in the wake state for a time period. The time period remained is the implicit listening interval. During this listening interval, the affiliated AP of the Soft AP MLD may respond to a request for association from an unassociated Non-AP MLD. In some embodiments, if there is a downlink data transmission request or an uplink data transmission request from an associated Non-AP MLD, then the affiliated AP of the Soft AP MLD may stay in a normal mode for data transmission for a specific period of duration. If no event occurs during the listening interval, then the affiliated AP returns to a sleeping state or a dozen state.

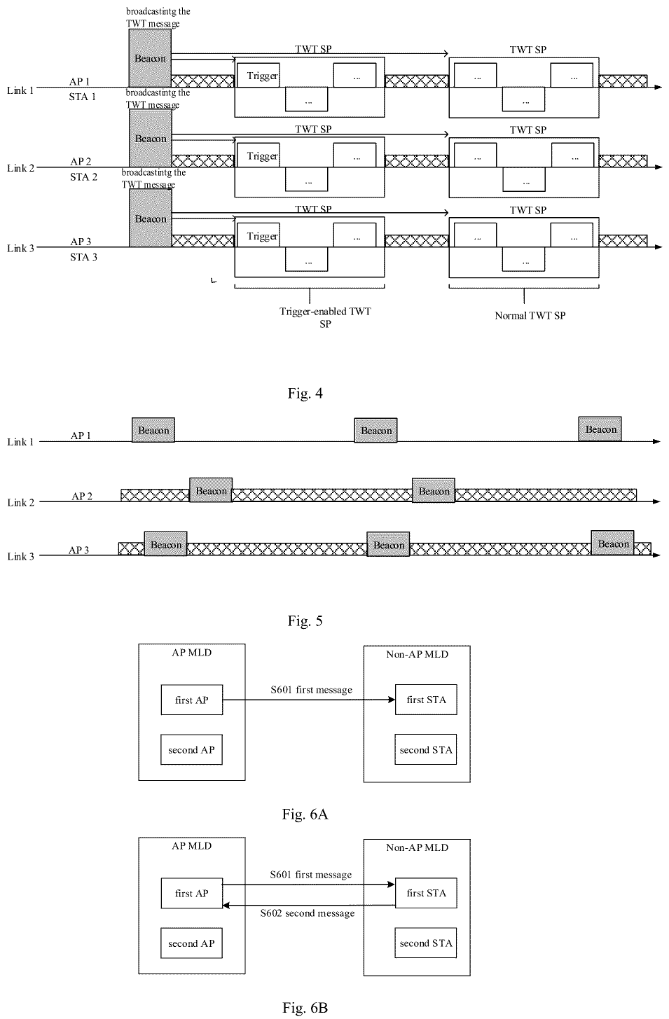

In the energy-saving approach A2, TWT is a certain time period, i.e., a service period (SP) negotiated between the STA and the AP. The frames are exchanged during the SP. Both the AP and the STA need to be in the wake state when the SP arrives. During the non-SP period, the STA and the AP may be in the sleeping state to save energy. As illustrated in FIG. 4, the affiliated AP of the Soft AP MLD broadcasts the TWT information, i.e., the Service Period (SP), via the Beacon frame. The affiliated APs of the Soft AP MLD and the affiliated non-AP STAs of the Non-AP MLD are clearly aware of the SP. During the non-TWT SP period, the affiliated APs of the AP MLD and the affiliated STA may be in the sleeping state to save energy. When the TWT SP arrives, the affiliated AP and the affiliated STA of the AP MLD are waked to provide service.

The energy-saving approach A3 is as illustrated in FIG. 5. The AP MLD selects one link (a link 1) as the primary link. The primary link is always in the active mode and responsible for transmitting the Beacon frames and performing the data transmission. The AP MLD disables other links (a link 2 and a link 3) or keeps the other links in the sleeping state to save energy. If the other links are in the sleeping state, these links are also able to be waked to transmit the Beacon frames and switch to the sleeping state immediately after transmitting the Beacon frames. The benefit of this energy-saving mode comes from the sleeping state of the secondary links.

The above technical schemes do not consider the primary-secondary link restriction of the Soft AP, in which the primary link is responsible for transmitting the Beacon frames and the secondary links cannot transmit the Beacon frames. Assuming that the link 1 and the link 2 form the NSTR link pair, and the link 1 is the primary link, then the link 2 is incapable of transmitting the Beacon frames. First, the restriction on the secondary link directly affects the AP MLD energy-saving mode based on any of the implicit listening interval in the approach A1 and the TWT-based energy-saving mode in the approach A2, since the state in which the link 2 is in can't be determined. Second, the energy-saving approach based on the primary link in the approach A3 reserves only one link and makes the other links unavailable. In this way, a kind of energy-saving approach may be provided, but the multiple links of the AP MLD could not be fully utilized, which limits the system's throughput.

To facilitate understanding of the technical scheme of embodiments of the present disclosure, the technical schemes of the present disclosure are detailed below through concrete embodiments. The following relevant technologies may be arbitrarily combined with the technical schemes of embodiments of the present disclosure as optional schemes, and they all belong to the protection scope of embodiments of the present disclosure. Embodiments of the present disclosure include at least some of the following contents.

Embodiments of the present disclosure provide a wireless communication method applied to the AP MLD. The method includes: a first access point AP affiliated with an access point multi-link device AP MLD transmits a first message over a first link to a first station STA affiliated with a non-access point multi-link device Non-AP MLD, the first message is configured to indicate whether a second AP affiliated with the AP MLD is in a wake state or an active state; and/or the first AP affiliated with the AP MLD receives, over the first link, a second message from the first STA affiliated with the Non-AP MLD, the second message is configured to request that the second AP affiliated with the AP MLD is in the wake state or the active state, or the second message is configured to indicate whether the second STA affiliated with the Non-AP MLD is in the wake state or the active state. The first AP and the first STA are over the first link, and the first link is the primary link. The second AP and the second STA are over the second link, and the second link is the secondary link.

Embodiments of the present disclosure provide a wireless communication method applied to the AP MLD. The method includes: the first STA affiliated with the Non-AP MLD receives, over the first link, the first message sent from the first AP affiliated with the AP MLD, the first message is configured to indicate whether the second AP affiliated with the AP MLD is in the wake state or the active state; and/or the first STA affiliated with the Non-AP MLD transmits the second message over the first link to the first AP affiliated with the AP MLD, the second message is configured to request that the second AP affiliated with the AP MLD is in the wake state or the active state, or the second message is configured to indicate whether the second STA affiliated with the Non-AP MLD is in the wake state or the active state. The first link is the primary link. The second link is the secondary link.

In the embodiments of the present disclosure, the APs affiliated with the AP MLD include the first AP and the second AP, and the STAs affiliated with the Non-AP MLD include the first STA and the second STA. The first link and the second link are further included between the AP MLD and the Non-AP MLD. The first AP is associated with the first STA over the first link. The second AP is associated with the second STA over the second link.

Alternatively, the first link and the second link form an NSTR link pair. The first link is the primary link, the first AP transmits the Beacon frame and the probe response frame to the first STA over the first link. The second link is the secondary link, the second AP does not transmit the Beacon frame and the probe response frame to the second STA over the second link.

In some embodiments of the present disclosure, a third link may further be included between the AP MLD and the Non-AP MLD. In the case where the first link is the primary link, the third link is a secondary link. In the case where the third link is included between the AP MLD and the Non-AP MLD, the AP MLD affiliates a third AP, the Non-AP MLD also affiliates a third STA, and the third AP associates with the third STA over the third link.

In some embodiments of the present disclosure, the Non-AP MLD may also be referred to as an STA MLD.

In some embodiments of the present disclosure, the messages that the first AP and the first STA exchange over the first link include one or both of the first message and the second message. The first message is sent from the first AP to the first STA. The second message is sent from the second STA to the first AP.

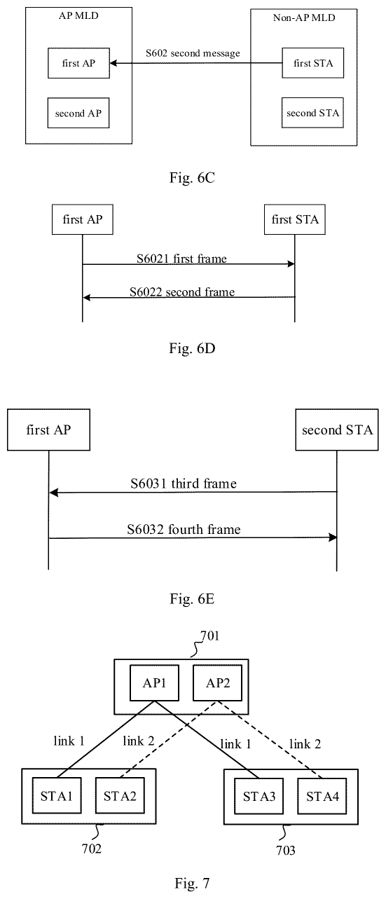

An example is illustrated where the messages exchanged between the first AP and the first STA over the first link include the first message, an interaction between the AP MLD and the Non-AP MLD includes the operation as illustrated in FIG. 6A.

Operation S601: the first AP transmits the first message to the first STA over the first link, and the first STA receives the first message sent by the first AP over the first link. The first message is configured to indicate whether the second AP affiliated with the AP MLD is in the wake state or the active state.

In response to the second AP being in the wake state or the active state, the first message is configured to indicate that the second AP is in the wake state or the active state. In response to the second AP being not in the wake state or the active state, the first message is configured to indicate that the second AP is not in the wake state or the active state.

Alternatively, the first message is also configured for traffic indication.

The first message being configured for the traffic indication includes at least one of the following cases: the first message indicates that pending traffic or to-be-transmitted traffic is traffic to be transmitted to the Non-AP MLD; and the first message indicates whether the link on which the pending traffic is mapped includes the second link.

The pending traffic may be construed as data to be transmitted.

An example is illustrated where messages exchanged between the first AP and the first STA over the first link include the first message and the second message. The interaction between the AP MLD and the Non-AP MLD includes operations as illustrated in FIG. 6B.

Operation S601: the first AP transmits the first message to the first STA over the first link, and the first STA receives the first message sent by the first AP over the first link.

Operation S602: in response to receiving the first message, the first STA transmits the second message to the first AP over the first link, and the first AP receives the second message sent by the first STA over the first link.

The first message is configured to indicate whether the second AP affiliated with the AP MLD is in the wake state or the active state. The second message is configured to request the second AP affiliated with the AP MLD to be in the wake state or the active state, or to indicate whether the second STA is in the wake state or the active state.

In response to the second AP being in the wake state or the active state, the first message is configured to indicate that the second AP is in the wake state or the active state. In response to the second AP being not in the wake state or the active state, the first message is configured to indicate that the second AP is not in the wake state or the active state.

Alternatively, the first message is further configured to indicate whether the link on which the pending traffic is mapped includes the second link.

In response to the first STA receiving the first message, the first STA transmits the second message to the first AP.

Alternatively, the second message is configured to request the second AP to be in the wake state or the active state.

Alternatively, the second message is configured to indicate whether the second STA is in the wake state or the active state.

The second message may explicitly request the second AP to be in the wake state or the active state, or indicate whether the second STA is in the wake state or the active state. Alternatively, the second message may implicitly request the second AP to be in the wake state or the active state or indicate whether the second STA is in the wake state or the active state.

Alternatively, in response to the second message implicitly requesting the second AP to be in the wake state or the active state or indicating that the second STA is in the wake state or the active state, an implicit request for the second AP to be in the wake state or the active state or an implicit indication that the second STA is in the wake state or the active state may be performed by the second message indicating that the link used to transmit the pending traffic includes the second link.

In response to the second message indicating that the link used to transmit the pending traffic includes the second link, it is considered that, the second message requests the second AP to be in the wake state or the active state, or indicates that the second STA is in the wake state or the active state. In response to the second message indicating that the link used to transmit the pending traffic does not include the second link, it is considered that, the second message does not request the second AP to be in the wake state or the active state, or indicates that the second STA isn't in the wake state or the active state.

In response to determining that, the link on which the pending traffic is mapped includes the second link, the Non-AP MLD controls the second STA to be in the wake state or the active state, and the first STA transmits the second message to the first AP. The second message is configured to request the second AP to be in the wake state or the active state, or the second message is configured to indicate that the second STA is in the wake state or the active state.

Here, the expression that the second message is configured to request the second AP to remain in the wake state or the active state, or the second message is configured to indicate that the second STA is in the wake state or the active state, may be construed as, the second message being configured to indicate that, the link used to transmit the pending traffic includes the second link.

An example is illustrated where messages exchanged between the first AP and the first STA over the first link include the second message. The interaction between the AP MLD and the Non-AP MLD includes operations as illustrated in FIG. 6C.

Operation S602: the first STA transmits the second message to the first AP over the first link, and the first AP receives the second message sent by the first STA over the first link.

The second message is configured to request the second AP to be in the wake state or the active state, or the second message is configured to indicate that whether the second STA is in the wake state or the active state.

In response to the Non-AP MLD determining that the link used to transmit the pending traffic includes the second link, the first STA transmits the second message to the first AP. The second message is configured to request the second AP to be in the wake state or the active state, or to indicate that the second STA is in the wake state or the active state.

In some embodiments of the present disclosure, the first message or the second message is exchanged between the first AP and the second AP. The first message is configured to indicate that, the link on which the pending traffic is mapped includes the second link. The second message is configured to indicate that, the link used to transmit the pending traffic includes the second link. The pending traffic is traffic to be transmitted between the AP MLD and the Non-AP MLD. Alternatively, the pending traffic is downlink traffic. A transmission direction of the downlink traffic is from the AP MLD to the Non-AP MLD. In other words, the downlink traffic is the traffic sent from the AP MLD to the Non-AP MLD. Alternatively, the pending traffic is uplink traffic. A transmission direction of the uplink traffic is from the Non-AP MLD to the AP MLD. In other words, the uplink traffic is the traffic sent from the Non-AP MLD to the AP MLD.

Alternatively, in response to the AP MLD determining that, the link on which the pending traffic is mapped includes the second link, the first AP transmits the first message to the first STA over the first link. The first message indicates that, the link on which the pending traffic is mapped includes the second link.

Alternatively, in response to the Non-AP MLD determining that, the link used to transmit the pending traffic includes the second link, the first STA transmits the second message to the first AP over the first link. The first message indicates that, the link used to transmit the pending traffic includes the second link.

In some embodiments, the AP MLD further implements the following operation: the AP MLD controls the second AP to be in the wake state or the active state.

An operating mode of the AP MLD is a first operating mode. Under the first operating mode, an operating mode of the second AP is a first energy-saving mode. Under the first energy-saving mode, an operating state of the second AP is the sleeping state, or the second AP is switchable between the sleeping state and the wake state.

Alternatively, in response to the AP MLD determining that the pending traffic is associated with the second link, the AP MLD controls the second AP that is originally in the sleeping state or the active state to be in the wake state or the active state. The operation of the AP MLD determining that the pending traffic is associated with the second link may include: determining that the link on which the pending traffic is mapped includes the second link, or determining that the link used to transmit the pending traffic includes the second link.

The operation of the AP MLD controlling the second AP to be in the wake state or the active state includes one or more of the following control approaches: a control approach 1, in response to the second AP being in the sleeping state, the AP MLD wakes the second AP to enter the wake state; a control approach 2, in response to the second AP being in the sleeping state, the AP MLD controls the second AP to be in the active state; a control approach 2, in response to the second AP being in the wake state, the AP MLD keeps the second AP in the wake state; and a control approach 3, in response to the second AP being in the wake state, the AP MLD controls the second AP to be in the active state.

In some embodiments of the present disclosure, the operating mode of the second AP is the first energy-saving mode, the operating state of the second AP at least includes the sleeping state, so as to realize energy saving of the AP MLD. In response to the AP MLP determining that the pending traffic is associated with the second link, the AP MLD controls the second AP on the second link to be in the wake state or the active state. In response to the AP MLD controlling the second AP on the second link to be in the wake state, the second AP keeps in the energy-saving mode. In response to the AP MLD controlling the second AP on the second link to be in the active state, the operating mode of the second AP switches from the energy-saving mode to a non-energy-saving mode.

In some embodiments, the AP MLD controls, at the first time point, the second AP to be in the wake state or the active state. A location of the first time point is before a time point when the first AP transmits the first message or after a time point when the second message is received.

In some embodiments, the location of the first time point is before the time point when the first AP transmits the first message. Based on a scenario illustrated in FIG. 6A, after the AP MLD controls the second AP to be in the wake state or the active state, the first AP transmits the first message to the first STA over the first link.

In some embodiments, the location of the first time point is before the time point when the first AP transmits the first message. Based on the scenario illustrated in FIG. 6B, after the AP MLD controls the second AP to be in the wake state or the active state, the first AP transmits the first message to the first STA over the first link, and receives the second message sent from the first STA.

In some embodiments, the location of the first time point is after the time point when the second message is received. Based on the scenario illustrated in FIG. 6B, the first AP transmits the first message to the first STA over the first link, and controls, in response to receiving the second message sent from the first STA, the second AP to be in the wake state or the active state.

In some embodiments, the location of the first time point is after the time point when the second message is received. Based on the scenario illustrated in FIG. 6C, in response to receiving the second message sent from the first STA, the first AP controls the second AP to be in the wake state or the active state.

Taking a case as an example where the first time point is located before the time point when the first AP transmits the first message, before the first AP transmits the first message, the AP MLD controls the second AP to be in the wake state or the active state, and the second AP is in the wake state or the active state. At this point, the first message indicates that the second AP is in the active state or the wake state.

Alternatively, the AP MLD determines that the link on which the pending traffic is mapped includes the second link, controls the second AP to be in the wake state or the active state, and the first AP transmits the first message to the first STA. The first message indicates that the second AP is in the active state or the wake state.

Alternatively, the link on which the pending traffic is mapped including the second link includes: a mapping case 1, the pending traffic is the downlink traffic, and an addressing approach of the pending traffic is group addressing; or, a mapping case 2, the pending traffic is the downlink traffic, the addressing approach of the pending traffic is an individual addressing, and the pending traffic is determined to be mapped to the second link based on link mapping information.

In response to the pending traffic being the downlink traffic, the AP MLD caches or buffers the pending traffic that is to be transmitted to the Non-AP MLD. The addressing approaches of the pending traffic include the group addressing and the individual addressing.

In the mapping case 1, the addressing approach of the pending traffic is the group addressing, the pending traffic is mapped to all links between the AP MLD and the Non-AP MLD.

In the mapping case 2, the addressing approach of the pending traffic is the individual addressing, the pending traffic is mapped to a part or all the links between the AP MLD and the Non-AP MLD. Here, the link mapping information is configured to determine whether the pending traffic is mapped to the second link.

Alternatively, the link mapping information is a mapping from the traffic to the link.

In some embodiments of the present disclosure, in response to the addressing approach of the pending traffic being the individual addressing, if the pending traffic is mapped to the second link, then there exists a possibility that the AP MLD uses the second link to transmit the pending traffic.

In some embodiments of the present disclosure, in response to the location of the first time point is before the time point when the first AP transmits the first message, after the AP MLD controls the second AP to be in the wake state or the active state, the second AP performs an enhanced distributed channel access (EDCA) mechanism on the second link, a backoff counter is decremented to zero. To ensure a synchronized transmission of the downlink data between the first AP and the second AP, the second AP maintains, keeps or freezes the backoff counter at zero according to the multi-link channel access rule, and waits for the first AP to perform the downlink data transmission.

Taking an example where the first time point is located after the time point when the first AP receives the second message, after the first AP receives the second message, the AP MLD controls the second AP to be in the wake state or the active state.

Alternatively, in response to determining, based on the second message, that the link used to transmit the pending traffic includes the second link, the AP MLD then controls the second AP to be in the wake state or the active state.

Alternatively, the AP MLD determining based on the second message, that the link used to transmit the pending traffic includes the second link includes: a usage case 1, where the pending traffic is the downlink traffic, the addressing approach of the pending traffic is the group addressing, the first AP receives the second message, and the second message is configured to request the AP MLD to transmit the pending traffic to the Non-AP MLD; or a usage case 2, where the pending traffic is the downlink traffic, the addressing approach of the pending traffic is the individual addressing, the first AP receives the second message, the second message is configured to transmit that, the link used to transmit the pending traffic includes the second link; or, a usage case 3, where the pending traffic is the uplink traffic, the first AP receives the second message, the second message is configured to transmit that, the link used to transmit the pending traffic includes the second link.

In some embodiments of the present disclosure, when the location of the first time point is after the time point when the second message is received, after the AP MLD controls the second AP to be in the wake state or the active state, the first AP performs the EDCA mechanism on the first link, the second AP performs the EDCA mechanism on the second link, the backoff counters are decremented to zero. To ensure the synchronized transmission of the downlink data between the first AP and the second AP, any one of the first AP and the second AP who has backed off to zero first would maintain its backoff counter at zero according to the multi-link channel access rule, and wait for another of the first AP and the second AP to perform the synchronization transmission of the downlink data.

In some embodiments, in response to the location of the first time point being before the time point when the first AP transmits the first message, in the wireless communication method provided according to some embodiments of the present disclosure, the AP MLD may implement the following steps: when the second AP is in the wake state or the active state, if the AP MLD determines that the first AP has not received the second message within a first time duration, the AP MLD controls the second AP to enter the sleeping state.

When the AP MLD controls the second AP to be in the wake state or the active state, a first timer is initiated. A time duration of the first timer is the first-time duration. If the first AP does not receive the second message until the first timer times out or expires, the AP MLD controls the second AP to enter the sleeping state.

Alternatively, the operating mode of the first AP is a second energy-saving mode. In other words, the operating state of the first AP is a sustained active state or a continuous active state, then the AP MLD may set the first timer. The time duration of the first timer is the first time duration. If the first AP does not receive the second message until the first timer times out, then the second AP enters the sleeping state.

Alternatively, the operating mode of the first AP is a third energy-saving mode. For example, the energy-saving mode of the first AP is based on the implicit listening interval). In other words, the operating state of the first AP may switch between the sleeping state and the wake state. The first time duration of the first timer is a sustained time duration (for example, the listening interval) of the wake state. When the first AP enters the sleeping state, if the second message has not been received, then the second AP also enters the sleeping state.

In some embodiments, in response to the location of the first time point is before the time point when the first AP transmits the first message, in the wireless communication method provided according to some embodiments of the present disclosure, the AP MLD may implement the following steps: when the second AP is in the wake state or the active state, if the AP MLD determines that the link used to transmit the pending traffic does not include the second link, then the AP MLD controls the second AP to enter the sleeping state.

After the AP MLD has controlled the second AP to be in the wake state or the active state, the first AP transmits the first message to the first STA, and receives the second message. The second message is returned to the first AP by the first STA in response to receiving the first message. In response to determining, based on the indication of the second message, that the link used to transmit the pending traffic does not include the second link, the AP MLD controls the second AP to switch from the wake state or the active state to the sleeping state.

In some embodiments, the first message includes a first frame. The first frame is sent by the first AP in the case where the AP MLD buffers the pending traffic to be transmitted to the Non-AP MLD. The first frame is configured to indicate that, the link on which the pending traffic is mapped includes the second link. The first frame is further configured to indicate that, the AP MLD buffers the pending traffic to be transmitted to the Non-AP MLD.

Here, the first frame is configured to indicate whether the link on which the pending traffic is mapped includes the second link, and/or the first frame is configured to indicate whether the second AP is in the wake state or the active state.

The AP MLD determines that, the pending traffic to be transmitted to the Non-AP MLD is buffered, and the link on which the pending traffic is mapped includes the second link, then the AP MLD generates the first frame.

The first frame is configured to indicate that, the AP MLD buffers the pending traffic to be transmitted to the Non-AP MLD, and the link on which the pending traffic is mapped includes the second link. The first AP transmits, over the first link, the first frame to the first STA. The first STA receives the first frame over the first link.

Alternatively, the first frame includes any one of the Beacon frame, the probe request frame and a management frame.

In response to receiving the first frame over the first link, the first STA transmits the second frame to the first AP over the first link. The second frame is configured to request the AP MLD to transmit the pending traffic to the Non-AP MLD.

In case where the Non-AP MLD determines that the link used to transmit the pending traffic includes the second link, and the first frame indicates that the second AP is not in the wake state or the control state, the second frame is configured to request the second AP to be in the wake state or the control state.

In case where the Non-AP MLD determines that the link used to transmit the pending traffic does not include the second link, the second frame is configured to indicate that the link used to transmit the pending traffic does not include the second link. This may be construed as, the second frame is not configured to request the second AP to be in the wake state or the active state, or does not indicate that the second STA is in the wake state or the active state.

In some embodiments, the second message includes: a second frame and/or a third frame.

The second frame is received by the first AP from the first STA. The second frame is configured to indicate that the link used to transmit the pending traffic includes the second link. In response to the first STA receiving the first frame sent from the first AP, the first STA transmits the second frame to the first AP.

The third frame is received by the first AP from the first STA. In response to the Non-AP MLD buffering the pending traffic to be transmitted to the AP MLD, the first STA transmits the third frame. The third frame is configured to indicate that the link used to transmit the pending traffic includes the second link.

Take the second message including the second frame as an example, in response to the pending traffic being the downlink traffic, the first AP transmits a first frame over the first link. The first STA receives the first frame sent by the first AP over the first link. The Non-AP MLD determines that the AP MLD buffers traffic to be transmitted to the Non-AP MLD based on the first frame, then the first STA transmits the second frame to the first AP, in order to request the AP MLD to transmit the pending traffic to the Non-AP MLD. Alternatively, in response to the link used to transmit the pending traffic including the second link, the second frame is also configured to indicate that, the link used to transmit the pending traffic includes the second link, such that the second frame implicitly indicates a request for the second AP to be in the wake state or the active state, or indicates that the second STA is in the wake state or the active state.

The first AP receives the second frame, and the second frame is configured to indicate that the link used to transmit the pending traffic includes the second link, in response to the second AP being in the wake state or the active state, the AP MLD would not change the state of the second AP. In response to the second AP being in the sleeping state, the AP MLD controls the second AP to be in the wake state or the active state.

Here, the second frame may be referred to as a downlink transmission indication frame.

Alternatively, the second frame is a QoS Null frame or a wrapped Power Save-Poll (PS-Poll) frame.

Take the second message including the third frame as an example, in response to the pending traffic being the uplink traffic, the Non-AP MLD buffers the pending traffic to be transmitted to the AP MLD, the Non-AP MLD generates the third frame, and the first STA transmits the third frame to the first AP over the first link. In response to the link on which the pending traffic is mapped includes the second link, the third frame is configured to request for transmitting the pending traffic to the AP MLD, and indicates that, the link used to transmit the pending traffic includes the second link, such that the third frame implicitly request the second AP to be in the wake state or the active state, or implicitly indicates that the second STA is in the wake state or the active state. In response to the first AP receiving the third frame and determining that the link used to transmit the pending traffic includes the second link, the AP MLD controls the second AP to be in the wake state or the active state.

Here, the third frame may be referred to as an uplink transmission indication frame.

Alternatively, the third frame is the QoS Null frame.

Alternatively, the operation of the AP MLD determining that the link used to transmit the pending traffic includes the second link includes the usage case 3. In the usage case 3, the first AP receives the third frame sent from the first STA, the third frame indicates that, the link used to transmit the pending traffic to the AP MLD includes the second link.

In the usage case 3, the pending traffic is the uplink traffic. The first AP receives the third frame sent by the first STA, the third frame is configured to request for transmission of the pending traffic to the AP MLD, and the third frame indicates that the link used to transmit the pending traffic to the AP MLD includes the second link. At this point, the AP MLD determines, based on the third frame, receipt of the pending traffic sent by the Non-AP MLD, and the link configured to receive the pending traffic includes the second link.

In some embodiments of the present disclosure, in response to the pending traffic being the downlink traffic, an interaction between the AP MLD and the Non-AP MLD includes operations as illustrated in FIG. 6D.

Operation S6021: the first AP affiliated with the AP MLD transmits the first frame to the first STA affiliated with the Non-AP MLD.

In response to determining that the traffic to be transmitted to the Non-AP MLD is buffered, the AP MLD broadcasts the first frame. The first STA listens to the first frame over the first link. The Non-AP MLD determines, based on the first frame, that the AP MLD buffers the traffic to be transmitted to the Non-AP MLD.

Operation S6022: the first STA affiliated with the Non-AP MLD transmits the second frame to the first AP affiliated with the AP MLD.

In response to the Non-AP MLD determining that the AP MLD buffers the traffic to be transmitted to the Non-AP MLD based on the first frame, the first STA transmits the second frame to the first AP based on the first link. The second frame is configured to request the AP MLD to transmit the pending traffic to the Non-AP MLD, and to indicate the link used for transmitting the pending traffic.

The timing of the AP MLD controlling the second AP to be in the wake state or the active state includes: a first timing, before the operation S6021; or a second timing, after the operation 6022.

Here, the first message includes the first frame, the second message includes the second frame.

In the first timing, the location of the first time point is before the time point when the first AP transmits the first frame.

Taking a case as an example where the timing of controlling the second AP to be in the wake state or the active state being the first timing, before the first AP transmits the first frame, the AP MLD determines that the link on which the pending traffic is mapped includes the second link, then constructing, based on controlling the second AP to be in the wake state or the active state, the first frame. The first AP transmits the first frame to the first STA over the first link. The first frame is configured to indicate that the second AP is in the wake state or the active state.

If the first AP does not receive the second frame within the first time duration, or if after reception of the second frame, determines, based on the second frame, that the link used to transmit the pending traffic does not include the second link, then the second AP is controlled to enter the sleeping state.

In the second timing, the location of the first timing is after the time point when the first AP receives the second frame. The AP MLD determines that the pending traffic to be transmitted to the Non-AP MLD is buffered.

Taking a case where the timing of controlling the second AP to be in the wake state or the active state being the second timing as an example, the first AP transmits, over the first link, the first frame to the first STA. The first frame is configured to indicate that the second AP is not in the wake state or the active state. After receipt of the first frame by the first STA, the Non-AP MLD determines that the pending traffic is the traffic to be transmitted to itself, the first STA determines that the link used to transmit the pending traffic includes the second link, the first STA transmits over the first link the second frame to the first AP. The second frame is configured to request the AP MLD to transmit the pending traffic to the Non-AP MLD, and to indicate the link used for transmitting the pending traffic. After receipt of the second frame by the first AP, if the AP MLD determines, based on the second frame, that the link used for the transmission of the pending traffic includes the second link, and the second AP is in the sleeping state or the wake state, then the AP MLD controls the second AP to be in the wake state or the active state.

In some embodiments of the present disclosure, the operation of the Soft AP MLD controlling the second AP to be in the wake state or the active state may be construed as the Soft AP MLD wakes the second AP.

In some embodiments of the present disclosure, when the Soft AP MLD determines that the link on which the pending traffic is mapped includes the second link, at this point, the Soft AP MLD has an option of whether to wake the second AP. In other words, the Soft AP MLD may or may not wake the second AP, and the Soft AP MLD transmits the fact of whether the second AP being in the wake state or the active state through the AP1 to the Non-AP MLD via the first frame.

Alternatively, if the Soft AP MLD does not wake the second AP, the second AP cannot use the second link for the traffic transmission afterwards, even if the second AP is actually in the wake state or the active state. This is because the Soft AP MLD does not wake the second AP, it cannot be guaranteed that the second AP is in the wake state during a frame exchange process, the second AP may return to the sleeping state in the middle of the frame exchange process.

If the first frame received by the Non-AP MLD indicates that the second AP is not in the wake state or the active state, then the second frame is sent by the first STA. Alternatively, the second frame cannot request an usage of the second AP for the transmission of the pending traffic, or the second frame requests the usage of the second AP for data transmission. At this point, after receipt of the second frame, the Soft AP MLD may disregard the second frame. In other words, during the frame exchange process, the second frame may not be used for the data transmission.

If the first frame received by the Soft AP MLD indicates that the second AP is in the wake state or the active state, the Non-AP MLD may choose to use or not to use the second link for the transmission of the pending traffic, and indicate the result of whether to use the second link for the transmission of the pending traffic in the second frame. The first STA transmits the second frame to the first AP over the first link.

In some embodiments, in response to the second message including the third frame, the AP MLD may further implement the following operation: the first AP affiliated with the AP MLD transmits a fourth frame in response to the third frame over the first link to the first STA. The fourth frame is configured to indicate whether the second AP is in the wake state or the active state.

At this point, the Non-AP MLD may implement the following operation: the first STA affiliated with the Non-AP MLD receives the fourth frame sent over the first link by the first AP. The fourth frame is in response to the third frame. The fourth frame is configured to indicate whether the second AP is in the wake state or the active state.

In some embodiments of the present disclosure, in response to the pending traffic being the uplink traffic, an interaction between the AP MLD and the Non-AP MLD includes operations as illustrated in FIG. 6E.

Operation S6031: the Non-AP MLD transmits the third frame to the AP MLD.

Operation S6032: the AP MLD transmits the fourth frame to the Non-AP MLD in response to the third frame.

A timing of the AP MLD controlling the second AP to be in the wake state or the active state includes: a third timing, after the operation 6032.

Here, the second message includes the third frame.

In the third timing, the location of the first time point is after the time point when the first AP receives the third frame.

If the Non-AP MLD determines that the pending traffic to be transmitted to the AP MLD is buffered, and the transmission of the pending traffic is mapped to the second link, then the first STA transmits the third frame over the first link to the first AP. The third frame is configured to indicate a request for transmitting the pending traffic to the AP MLD, and the link used to transmit the pending traffic includes the second link. In this way, the AP MLD is requested to control the second AP to be in the wake state or the active state.

Before the first STA transmits the third frame, the Non-AP MLD determines the operating state of the second STA, and determines that whether the link used to transmit the pending traffic includes the second link according to the state of the second STA. In response to the state of the second STA being in the wake state or the active state, the link used to transmit the pending traffic is determined to include the second link. At this point, the second frame is configured to request the second AP to be in the wake state or the active state or is configured to indicate that the second STA is in the wake state or the active state. In response to the state of the second STA being in the sleeping state, the link used to transmit the pending traffic is determined to not include the second link. At this point, the second frame is configured to indicate that the second STA is not in the wake state or the active state.

The first AP receives the third frame. The AP MLD indicates, based on the third frame, that the link used to transmit the pending traffic includes the second link, controls the second AP to be in the wake state or the active state, and generates the fourth frame. The first AP transmits the fourth frame to the first STA. The fourth frame is configured to indicate whether the second AP is in the wake state or the active state.

Alternatively, the fourth frame is a wrapped Block ACK (BA) frame.

In some embodiments, the first frame carries a sixth indication message. The sixth indication message is configured to indicate whether the second AP is in the wake state or the active state.

The sixth indication message is carried in a control field of the first frame. The control field may be an indication element or an action element.

Alternatively, the indication element is a newly added element in the first frame.

Alternatively, the indication element includes: an element identification field, a length field and a data field. The data field includes a state indication information. The element identification field uniquely identifies the indication element. The length field indicates a length of the indication element. The sixth indication message in the data field is configured to indicate whether the second AP is in the wake state or the active state.

In an example, a sixth identifier is a bit of the data field, and different bits correspond to different links. If a bit corresponding to the second link takes a value of a sixth value, then the second AP is indicated to be in the wake state or the active state. If the bit corresponding to the second link takes a value different from the sixth value, then the second AP is indicated to be not in the wake state or the active state. In some embodiments, the sixth value is 1.

Alternatively, the action element includes a category field and the data field including the sixth indication message. The category field uniquely identifies this action frame. The sixth indication message in the data field is configured to indicate whether the second AP is in the wake state or the active state.

Alternatively, the sixth indication message is the sixth identifier. The sixth identifier taking the value of the sixth value is configured to indicate that the second AP is in the wake state or the active state. If the sixth identifier takes the value of the sixth value, then the second AP is indicated to be in the wake state or the active state. If the sixth identifier takes a value other than the sixth value, then the second AP is indicated to be not in the wake state or the active state.

In some embodiments, the first frame carries a first indication message. The first indication message is configured to indicate that the pending traffic is the traffic to be transmitted to the Non-AP MLD.

The first AP transmits the first frame to the first STA at a set time point for transmitting the first frame over the first link.

Alternatively, at the set time point for transmitting the first frame, the operating state of the first AP is the active state, the sleeping state, or the wake state.

Take a case where the operating state of the first AP is the active state or the wake state at the set time point for transmitting the first frame as an example, the first AP transmits the first frame at the set time points for transmitting the first frame over the first link.

Take a case where the operating state of the first AP is the sleeping state at the set time point for transmitting the first frame as an example, at the set time point for transmitting the first frame over the first link, the AP MLD wakes the first affiliated AP to be in the wake state and transmits the first frame.

If the AP MLD determines that the pending traffic to be transmitted to the Non-AP MLD is buffered, then the first indication message is carried in the first frame sent to the first STA by the first AP. The first frame carrying the first indication message is further configured to indicate that, the AP MLD buffers the pending traffic to be transmitted to the Non-AP MLD.

Alternatively, the first indication message is carried in a traffic indication map (TIM) element of the first frame.

In response to receiving the first frame carrying the first indication message, the first STA determines, based on the first indication message carried in the first frame, that the traffic to be transmitted to the Non-AP MLD is buffered in the AP MLD. The traffic to be transmitted to the Non-AP MLD is the pending traffic.

In some embodiments, the first indication message is a first identifier. The first identifier taking the value of a first value is configured to indicate that, the pending traffic is the downlink traffic to be transmitted to the Non-AP MLD.

The first value may be set on demand.

The AP MLD determines the value of the first identifier based on to which Non-AP MLD the pending traffic is sent. If the pending traffic is sent to a Non-AP MLD, then the identifier corresponding to the Non-AP MLD, i.e., the value of the first identifier, is the first value. If the pending traffic is not sent to the Non-AP MLD, then the identifier corresponding to the Non-AP MLD, i.e., the value of the first identifier, is not the first value. Alternatively, the first value is 1.

Alternatively, in a case where the first frame is received by the first STA, the Non-AP MLD determines whether the pending traffic is the traffic to be transmitted to the current Non-AP MLD based on whether the identifier, which is carried by the first frame and takes the value of the first value, is the first identifier corresponding to the Non-AP MLD. If the value of the first identifier is the first value, then the pending traffic is the traffic to be transmitted to the current Non-AP MLD. If the value of the first identifier is a value other than the first value, then the pending traffic is not the traffic to be transmitted to the current Non-AP MLD.

In some embodiments, the first identifier is a bit of a partial virtual bitmap of the first frame corresponding to the Non-AP MLD.

Alternatively, the first identifier includes one or more bits.

Different identifiers in the partial virtual bitmap correspond to Association IDs (AID) of different Non-AP MLDs. Different AIDs identify different Non-AP MLDs. If the AP MLD determines that the pending traffic is to be transmitted to one Non-AP MLD, then the identifier of the partial virtual bitmap corresponding to the one Non-AP MLD, i.e., the first identifier is set as the first value.

Take a case where the first identifier includes one bit as an example, different bits in the partial virtual bitmap correspond to AIDs of different Non-AP MLDs. In the case where the AP MLD determines that the pending traffic is the traffic to be transmitted to one Non-AP MLD, a bit of the partial virtual bitmap corresponding to that Non-AP MLD is set as the first value. The first STA receives the first frame. The Non-AP MLD determines, based on the value of the first identifier in the partial virtual bitmap in the first frame being the first value, that the pending traffic is the traffic to be transmitted to the Non-AP MLD.

In some embodiments, the first frame carries a second indication message. The second indication message is configured to indicate that the link on which the pending traffic is mapped includes the second link.

Alternatively, the second indication message is carried in a multi-link traffic element or a delivery traffic indication map (DTIM) element of the first frame.

The AP MLD indicates to the Non-AP MLD, based on the second indication message, that the link on which the pending traffic is mapped includes the second link.

In some embodiments, the second indication message is a second identifier. The second identifier taking a second value is configured to indicate that, the link on which the pending traffic is mapped includes the second link.

The AP MLD determines the value of the second identifier based on the link on which the pending traffic is mapped. In response to the link on which the pending traffic is mapped including the second link, the value of the second identifier is the second value. In response to the link on which the pending traffic is mapped not including the second link, the value of the second identifier is a value other than the second value. Alternatively, the second value is 1.

Alternatively, in a case where the first frame is received by the first STA, the Non-AP MLD determines, based on the value of the second identifier carried by the first frame, whether the link on which the pending traffic is mapped includes the second link. In response to the value of the second identifier being the second value, the link on which the pending traffic is mapped includes the second link. In response to the value of the second identifier being not the second value, the link on which the pending traffic is mapped does include the second link.

In some embodiments, in a case where the addressing mode of the pending traffic is the group addressing, the second identifier is a bit of the delivery traffic indication map DTIM element.

Take a case where the AP MLD indicates the link on which the pending traffic is mapped to the Non-AP MLD as an example, if the pending traffic is the group-addressed traffic, then the AP MLD indicates to the Non-AP MLD, through the second identifier indication message in the DTIM element of the first frame, that the addressing approach of the current pending traffic is the group addressing.

Alternatively, the second identifier is a bit of the bitmap control field of the DTIM element. The second identifier includes one or more bits.

In one example, if a bit 0 of the bitmap control field of the DTIM element is set as 1, then it is indicated that, the addressing approach of the current pending traffic is the group addressing.

The Non-AP MLD determines, based on a group addressing indication information of the DTIM element, that the addressing approach of the current pending traffic is the group addressing. In other words, the pending traffic is mapped to all links.

In some embodiments, in a case where the addressing approach of the pending traffic is the individual addressing, the second identifier is a bit of the multi-link traffic element corresponding to the second link.

Take a case where the AP MLD indicates to the Non-AP MLD, based on the multi-link traffic element, the link on which the pending traffic is mapped as an example, if the pending traffic is an individual addressing traffic, then the link on which the pending traffic is mapped is indicated through the multi-link traffic element of the first frame. Alternatively, the multi-link traffic element includes a plurality of multi-link traffic indication bitmaps. Different multi-link traffic indication bitmaps correspond to different Non-AP MLDs. The multi-link traffic indication bitmap of the multi-link traffic element corresponding to the first indication message is the multi-link traffic indication bitmap corresponding to the Non-AP MLD. In the multi-link traffic indication bitmap, different identifiers correspond to different links of the Non-AP MLD.

Here, the second indication message indicates the multi-link traffic bitmap of the plurality of multi-link traffic bitmaps in the multi-link traffic element corresponding to the Non-AP MLD.

In response to receiving the first frame carrying indication messages, the Non-AP MLD determines, based on the first indication message and the second indication message carried by the first frame, the pending traffic being buffered in the AP MLD and the link on which the pending traffic is mapped. The pending traffic is the traffic to be transmitted to the Non-AP MLD.

In some embodiments, the second frame carries a third indication message. The third indication message is configured to indicate that the link used to transmit the pending traffic includes the second link.

In some embodiments, the third indication message is a third identifier. The third identifier taking the value of a third value is configured to indicate that the link used to transmit the pending traffic includes the second link.

The third identifier is located in a first link field of the second frame. The first link field includes identifiers corresponding to different links. The third identifier is an identifier in the first link field corresponding to the second link. If the Non-AP MLD determines that the pending traffic is to be received over the second link, then the value of the third identifier is set as the third value. If the Non-AP MLD determines that the pending traffic is not to be received over the second link, then the value of the third identifier is set as a value other than the third value.

If the value of the third identifier in the second frame received by the AP MLD is the third value, then it is determined that the second link is used to transmit the pending traffic. If the value of the third identifier in the second frame received by the AP MLD is a value other than the third value, then it is determined that the second link is not used to transmit the pending traffic. Alternatively, the third value is 1.

Alternatively, in a case where the first frame is received by the first STA, the Non-AP MLD determines, based on the first indication message carried by the first frame, that the pending traffic to be transmitted to the Non-AP MLD is buffered in the AP MLD, and determines the state of the first STA. If the first STA is in the sleeping state, then the value of the third identifier is set as a value other than the third value. If the first STA is in the wake state or the active state, then the value of the third identifier is set as the third value.

In some embodiments, a third indication message is carried in the first link field of the second frame. The first link field is a first control field or a second control field. The first control field includes: a control identifier subfield and a data subfield including the third indication message. The second control field includes: a control identifier subfield, a type subfield and a data subfield including the third indication message.

The first link field may be located in an A-Control field of a QoS Null frame or a wrapped PS-Poll frame.

In the first control field, the control identifier subfield is configured to identify the current link field as the first link field of the second frame. The data subfield carries the third indication message. Alternatively, the control identifier subfield includes 4 bits.

In the second control field, a control identifier word is configured to identify the current link field for waking the second AP. The type subfield is configured to identify the current link field as the first link field of the second frame. The data subfield carries the third indication message. Alternatively, the control identifier field includes 4 bits, and the type subfield includes 2 bits.

In some embodiments, the third frame carries a fourth indication message. The fourth indication message is configured to indicate that the link used to transmit the pending traffic includes the second link.

Here, the timing of the AP MLD controlling the second AP to be in the wake state or the active state is the second timing. The second timing is after the time point when the first AP receives the third frame over the first link. The second timing here may be construed as the timing of the usage case 3 for controlling the second AP to be in the wake state or the active state.

Alternatively, in response to receiving the third frame, if the AP MLD determines, based on the third frame, that the pending traffic to be transmitted to the AP MLD is buffered in the Non-AP MLD, then the pending traffic needs to be received over the second link, thus the second AP is controlled to be in the wake state or the active state.

The Non-AP MLD determines that the traffic to be transmitted to the AP MLD, i.e., the pending traffic is buffered, and determines the link on which the pending traffic is mapped based on the mapping from the traffic to the link. Here, if the link on which the pending traffic is mapped includes the second link, then the third frame is generated based on the fourth indication message. The third frame is configured to request for transmitting the pending traffic to the AP MLD. The third frame carries the fourth indication message, for requesting the usage of the second link to transmit the pending traffic to the AP MLD. Alternatively, the pending traffic is the uplink transmission traffic. The third frame may be referred to as the uplink transmission indication frame.

The AP MLD receives the third frame carrying the fourth indication message, determines that the pending traffic to be transmitted to the AP MLD is buffered in the Non-AP MLD, and determines, based on the fourth indication message carried by the third frame, that the pending traffic is received over the second link.

In some embodiments, the fourth indication message is also configured to indicate that the operating state of the second STA affiliated with the Non-AP MLD is the active state or the wake state.

Here, in a case where the operating state of the second STA over the second link is the active state or the wake state, if the Non-AP MLD determines that the pending traffic is transmitted over the second link, then the AP MLD determines, based on the fourth indication message carried in the third frame, that the operating state of the second STA is the active state or the wake state.

In some embodiments, the fourth indication message is a fourth identifier. The fourth identifier taking the value of a fourth value is configured to indicate that the link used to transmit the pending traffic includes the second link.

If the AP MLD determines that the pending traffic is to be sent over the second link, then the value of the fourth identifier is set as the fourth value. If the AP MLD determines that the pending traffic is not to be sent over the second link, then the value of the fourth identifier is set as a value other than the fourth value.

If the value of the fourth identifier of the third frame received by the first AP is the fourth value, then the AP MLD determines that the second link is used to receive the pending traffic. If the value of the fourth identifier of the third frame received by the first AP is a value other than the fourth value, then the AP MLD determines that the second link is not used to receive the pending traffic. Alternatively, the fourth value is 1.

In some embodiments, the fourth identifier is a bit of the third frame corresponding to the second link.

The fourth identifier is located in a second link field of the third frame. The second link field includes identifiers corresponding to different links. The fourth identifier is an identifier in the second link field corresponding to the second link.

In some embodiments, the fourth indication message is carried in the second link field of the third frame. The second link field is a third control field or a fourth control field. The third control field includes: a control identifier subfield and a data subfield including the fourth indication message. The fourth control field includes: a control identifier subfield, a type subfield and a data subfield including the fourth indication message.

The second link field may be located in the A-Control field of the QoS Null frame.

In the third control field, the control identifier subfield is configured to identify the current link field as the second link field of the third frame. The data subfield carries the fourth indication message. Alternatively, the control identifier subfield includes 4 bits.

In the third control field, a control identifier word is configured to identify the current link field for waking the second AP, the type subfield is configured to identify the current link field as the second link field of the third frame, and the data subfield carries the fourth indication message. Alternatively, the control identifier field includes 4 bits, and the type subfield includes 2 bits.

In some embodiments, the fourth frame carries a fifth indication message. The fifth indication message is configured to indicate the operating state of the second AP.

The AP MLD generates the fifth indication message based on the operating state of the second AP when generating the fourth frame, and carries the fifth indication message in the fourth frame, to notify the operating state of the second affiliated AP to the Non-AP MLD through the fifth indication message.

In some embodiments, the fifth indication message is a fifth identifier. The fifth identifier taking the value of a fifth value is configured to indicate the operating state of the second AP as the wake state or the active state.

If the operating state of the second AP is the wake state or the active state, the value of the fifth identifier is set by the AP-MLD as the fifth value. If the operating state of the second AP is the sleeping state, the value of the fifth identifier is set by the AP-MLD as a value other than the fifth value. Alternatively, the fifth value is 1.

In response to the value of the fifth identifier of the fourth frame received by the first STA being the fifth value, the Non-AP MLD determines that the second AP is in the wake state or the active state. In response to the value of the fifth identifier of the fourth frame received by the first STA being the fifth value, the Non-AP MLD determines that the second AP is in the sleeping state.

In some embodiments, the fifth identifier is a bit of the fourth frame corresponding to the second link.

The fourth frame is provided with identifiers for different links. The fifth identifier is an identifier corresponding to the second link.

The fifth identifier is located in a third link field of the fourth frame. The third link field includes bits corresponding to different links, i.e. bits corresponding to different APs. The fifth identifier includes one or more bits of the third link field corresponding to the second link.

In some embodiments, the fifth indication message is carried in the third link field of the fourth frame. The third link field is a fifth control field and/or a sixth control field. The fifth control field includes: a control identifier subfield and a data subfield including the fifth indication message. The sixth control field includes: a control identifier subfield, a type subfield and a data subfield including the fifth indication message.

The third link field may be located in the A-Control field in the wrapped BA frame.

In the fifth control field, the control identifier subfield is configured to identify the current link field as the third link field of the fourth frame. The data subfield carries the fifth indication message. Alternatively, the control identifier subfield includes 4 bits.

In the sixth control field, a control identifier word is configured to identify the current link field for waking the second AP, the type subfield is configured to identify the current link field as the third link field of the fourth frame, and the data subfield carries the fifth indication message. Alternatively, the control identifier field includes 4 bits, and the type subfield includes 2 bits.

In some embodiments of the present disclosure, the third indication message, the fourth indication message and the fifth indication message are located in the link fields of different frames respectively. If the link field includes the third indication message, then the link field is the first link field, and the first link field is in the second frame. If the link field includes the fourth indication message, then the link field is the second link field, and the second link field is in the third frame. If the link field includes the fifth indication message, then the link field is the third link field, and the third link field is in the fourth frame.

The third indication message, the fourth indication message and the fifth indication message are located in data subfields of different link fields.

Alternatively, the link field includes a control ID subfield and a data subfield. Here, the control ID subfield is configured to identify the current link field as the first link field, the second link field or the third link field.

Alternatively, the link field includes a control ID subfield, a type subfield, and a data subfield. Here, the control ID subfield is configured to identify the current link field as one of the first link field, the second link field or the third link field. The type subfield is configured to identify the current link field as the first link field, the second link field or the third link field.

In some embodiments, the data subfield includes at least one of: a link identifier field; and a link identifier bitmap field.

Here, the bit number of the link identifier field is 4. The link identifier field may correspond to at least 4 links.

The bit number of the link identifier bitmap field may be expanded according to actual needs, and is able to correspond to the number of links that corresponds to the expanded bit number.

In some embodiments, in the wireless communication method provided according to some embodiments of the present disclosure, the AP MLD may further implement the following operations: the AP MLD transmits the pending traffic to the Non-AP MLD over the first link and the second link; or the AP MLD receives the pending traffic from the Non-AP MLD over the first link and the second link.

At this point, the Non-AP MLD may implement the following operations: the Non-AP MLD receives the pending traffic from the AP MLD over the first link and the second link; or the Non-AP MLD transmits the pending traffic to the AP MLD over the first link and the second link.

In a case where the pending traffic is the downlink traffic, the first AP and the second AP of the AP MLD transmit the data of the pending traffic to the Non-AP MLD over the first link and the second link respectively. The first STA of the Non-AP MLD receives the data of the pending traffic from the first AP over the first link. The second STA of the Non-AP MLD receives the data of the pending traffic from the second AP over the second link. In this way, the transmission of data traffic from the AP MLD to the Non-AP MLD is realized.

In a case where the pending traffic is the uplink traffic, the first STA of the Non-AP MLD transmits the data of the pending traffic to the first AP over the first link, the second STA of the Non-AP MLD transmits the data of the pending traffic to the second AP over the second link, the first AP of the Non-AP MLD receives the data of the pending traffic from the first STA over the first link, and the second AP of the Non-AP MLD receives the data of the pending traffic from the second STA over the second link. In this way, the transmission of data traffic from the Non-AP MLD to the AP MLD is realized.

In some embodiments of the present disclosure, the Non-AP MLD and the AP MLD interacting for the pending traffic may be construed as exchange of frame formats.

In some embodiments, after the transmission of the pending traffic is completed, the AP MLD controls the second AP to enter the sleeping state.

In some embodiments, the operating mode of the AP MLD is independent from the operating mode of the Non-AP MLD.

Here, the operating mode of the AP MLD is the first operating mode, the operating mode of the Non-AP MLD is the second operating mode. The first operating mode is different from the second operating mode.

In some embodiments, the operating mode of the AP MLD is the first operating mode. Under the first operating mode, the operating state of the second AP at least includes the sleeping state.

Alternatively, under the first operating mode, the operating state of the second AP is always the sleeping state.

Alternatively, under the first operating mode, the operating state of the second AP includes the sleeping state and the wake state.

In some embodiments, under the first operating mode, the operating mode of the second AP is the first energy-saving mode. Under the first energy-saving mode, the operating state of the second AP is the sleeping state. In some embodiments, the operating state of the second AP under the first energy-saving mode includes the sleeping state and the wake state.

If the operating state of the second AP under the first energy-saving mode is the sleeping state, then the second AP is always in the sleeping state. In response to the AP MLD determining that the pending traffic is associated with the second AP, the second AP is controlled to be in the wake state or the active state.

If the operating state of the second AP under the first energy-saving mode includes the sleeping state and the wake state, then the operating state of the second AP switches between the sleeping state and the wake state. If the AP MLD determines that the pending traffic is associated with the second AP, and the second AP is in the sleeping state, then the second AP is controlled to be in the wake state or the active state. If the AP MLD determines that the pending traffic is associated with the second AP, and the second AP is in the wake state, then the second AP affiliated with the AP MLD is kept in the wake state or the second AP is controlled to be in the active state.

Alternatively, under the first energy-saving mode, the operating state of the second AP includes the sleeping state and the wake state.

The first energy-saving mode includes at least one of the following: the energy-saving mode based on implicit listening interval, the energy-saving mode based on the target wake time (TWT), and the energy-saving mode based on the wireless network management sleeping interval.

In some embodiments, under the first operating mode, the operating mode of the first AP includes one of the following: the second energy-saving mode, and a third energy-saving mode.

The operating state of the first AP under the second energy-saving mode is the active state.

The operating state of the first AP under the third energy-saving mode includes the sleeping state and the wake state.

Under the second energy-saving mode, the operating state of the first AP is always in the active state.

In a scenario where the pending traffic is the downlink traffic, the first AP is in the active state in a case where: the first AP transmits the first frame to the first STA over the first link at the set time point when the first frame needs to be sent, and the first AP receives or does not receive the second frame in response to the first frame.

In a case where the pending traffic is the uplink traffic, the first AP is in the active state whether or not the third frame is received.

Under the third energy-saving mode, the operating state of the first AP includes the sleeping state and the wake state. Alternatively, the third energy-saving mode includes at least one of the following: the energy-saving mode based on the implicit listening interval, the energy-saving mode based on the TWT, the energy-saving mode based on the wireless network management sleeping interval.

In a scenario where the pending traffic is the downlink traffic, the first AP switches from the sleeping state to the wake state, and transmits the first frame to the first STA over the first link. Upon receiving the second frame in response to the first frame, the first AP continues to be in the wake state or switches to the active state. If the second frame is not received, the first AP enters the sleeping state.

In a case where the pending traffic is the uplink traffic, after the first AP switches from the sleeping state to the wake state or the active state, it listens for the third frame sent from the first STA. If the third frame is received during the listening interval, then the first AP continues to remain in the wake state or the active state. If the third frame is not received during the listening interval, then the first AP enters the sleeping state.

In some embodiments of the present disclosure, the operating states of the first AP and the second AP are one of the following combinations: a combination A1, where the operating state of the first AP is the active state, the operating state of the second AP is the sleeping state; a combination A2, where the operating state of the first AP includes the sleeping state and the wake state, the operating state of the second AP is the sleeping state; a combination A3, where the operating state of the first AP is the active state, the operating state of the second AP includes the sleeping state and the wake state; a combination A4, where the operating state of the first AP includes the sleeping state and the wake state, the operating state of the second AP includes the sleeping state and the wake state.

In some embodiments, the operating mode of the Non-AP MLD is the second operating mode. Under the second operating mode, the operating mode of the first STA or the second STA affiliated with the Non-AP MLD includes one of a fourth energy-saving mode and a fifth fourth energy-saving mode. The operating state of the first STA or the second STA under the fourth energy-saving mode is the active state. The operating state of the first STA or the second STA under the fifth energy-saving mode includes the sleeping state and the wake state.

Take the first STA as an example, the operating mode of the first STA may be the fourth energy-saving mode or the fifth energy-saving mode.

In a scenario where the operating mode of the first STA is the fifth energy-saving mode and the pending traffic is the uplink traffic, in response to determining that the pending traffic is mapped to the second STA, the Non-AP MLD wakes the second STA from the sleeping state, or remains the state of the second STA in the wake state, until the transmission of the pending traffic is completed. Then the second STA enters the sleeping state.

In a scenario where the operating mode of the first STA is the fourth energy-saving mode and the pending traffic is the downlink traffic, in response to receiving the first frame sent by the first AP, the first STA is able to transmit the second frame to the first AP in response to the first frame, such that the first AP is able to receive the second frame within the first time duration.

In a scenario where the operating mode of the first STA is the fourth energy-saving mode, and the pending traffic is the uplink traffic, in response to the Non-AP MLD determining an existence of the pending traffic to be transmitted to the AP MLD, the first STA transmits the third frame to the AP MLD.

In a scenario where the operating mode of the first STA is the fifth energy-saving mode, and the pending traffic is the downlink traffic, the first STA, in a case of receiving the first frame sent by the first AP while the first STA is in the sleeping state, does not respond to the first frame until it switches from the sleeping state to the wake state, detects the received first frame, and transmits the second frame to the first AP. In this way, the first AP does not receive the second frame within the first time duration. In a case where the first STA receives the first frame sent by the first AP in the wake state, the first STA transmits the second frame to the first AP in response to the first frame, such that the first AP is able to receive the second frame within the first time duration.

In a scenario where the operating mode of the first STA is the fifth energy-saving mode, and the pending traffic is the uplink traffic, in case the Non-AP MLD determines the existence of the pending traffic to be transmitted to the AP MLD, if the first STA is in the sleeping state, then the first STA would not transmit the third frame until it switches from the sleeping state to the wake state, detects the buffered pending traffic and transmits the third frame to the first AP. If the first STA is in the wake state, it transmits the third frame to the first AP.

Take the second STA as an example, the operating mode of the second STA may be the fourth energy-saving mode or the fifth energy-saving mode.

In a scenario where the operating mode of the second STA is the fifth energy-saving mode and the pending traffic is the downlink traffic, in response to determining, based on the first frame, that the pending traffic is mapped to the second STA, the Non-AP MLD wakes the second STA in the sleeping state to the wake state or the active state, or remains the state of the second STA in the wake state, or switches the second STA from the wake state to the active state, until the transmission of the pending traffic is completed. Then the second STA enters the sleeping state.

In some embodiments, the operating modes of the first STA and the second STA may be the same or different.

In some embodiments of the present disclosure, the operating states of the first STA and the second STA are one of the following combinations: a combination B1, where the operating state of the first STA is the active state, and the operating state of the second STA is the active state; a combination B2, where the operating state of the first STA is the active state, and the operating state of the second STA includes the sleeping state and the wake state; a combination B3, where the operating state of the first STA includes the sleeping state and the wake state, and the operating state of the second STA is the active state; a combination B4, where the operating state of the first STA includes the sleeping state and the wake state, and the operating state of the second STA includes the sleeping state and the wake state.

In the following, the wireless communication method provided according to embodiments of the present disclosure is described in conjunction with a communication system as illustrated in FIG. 7.

The communication system illustrated in FIG. 7 includes: two affiliated APs within the AP MLD 701, namely the AP1 and the AP2. The AP1 corresponds to the first AP. The AP2 corresponds to the second AP. The AP1 operates over the link 1, the link 1 corresponds to the first link. The AP2 operates over the link 2, the link 2 corresponds to the second link. The link 1 and the link 2 form an NSTR link pair for the AP MLD. The link 1 is the primary link. The link 2 is the secondary link. The AP1 is associated with the STA1 affiliated with the Non-AP MLD 702 and the STA3 affiliated with the Non-AP MLD 703 over the link 1. The AP2 is associated with the STA2 affiliated with the Non-AP MLD 702 and the STA4 affiliated with the Non-AP MLD 703 over the link 2.

The following transmission restriction is currently imposed on AP MLDs in 11be Draft 1.0: if an affiliated AP of an AP MLD or an affiliated STA of a Non-AP MLD associated with the AP MLD intends to initiate a PHY protocol data unit (PPDU) transmission over the secondary link, then it is required that another affiliated APs/STAs of the same MLD also initiates a PPDU transmission over the primary link at the same time as a role of a TXOP holder. Therefore, if the primary link of the current AP MLD is not in use, then the secondary link must not be in use either. Only if the primary link is in use, the secondary link can be in use.

In some embodiments of the present disclosure, the affiliated AP1 of the AP MLD operates over the primary link always remains in the active state or in the energy-saving state. The energy-saving mode is for example the energy-saving mode based on the implicit listening interval as illustrated in FIG. 3. The energy-saving mode based on the implicit listening interval as illustrated in FIG. 3 would not affect the AP1's process of transmitting the Beacon frame and the probe response frame. The affiliated AP2 operating over the secondary link is in the energy-saving state. Similarly, the AP2 may have a plurality of energy-saving modes, such as always remaining in the sleeping state or being in some kind of energy-saving modes. The AP1 and the AP2 contribute energy-saving gains to the AP MLD when they are in the energy-saving state. Combining the energy-saving states of both the AP1 and the AP2, the AP MLD may have a plurality of energy-saving states: an energy-saving state 1, where the AP1 is always in the active state, and the AP2 is always in the sleeping state; an energy-saving state 2, where the AP1 is always in the active state, and the AP2 is in the energy-saving mode 1; an energy-saving state 3, where the AP1 is always in the energy-saving mode 2, and the AP2 is always in the sleeping state; an energy-saving state 4, where the AP1 is always in the energy-saving mode 2, and the AP2 is in the energy-saving mode 1.

The wireless communication method provided in embodiments of the present disclosure may provide a wake mechanism for the AP2 of the AP MLD in the energy-saving state.

Regarding the AP MLD, before a downlink transmission, if it is determined that the secondary link is possibly to be used for transmission, then the affiliated AP2 is waked or the operating state of the affiliated AP2 remains in the wake state or the active state, to avoid a situation in which the AP MLD performs transmission over the two links while the AP2 remains in the sleeping state.

Regarding the NON-AP MLD, before the downlink transmission, the STA1 of the NON-AP MLD over the primary link transmits a transmission indication frame to the AP MLD, to indicate whether to perform the transmission over the secondary link. Before an uplink transmission, the STA1 of the NON-AP MLD over the primary link transmits the transmission indication frame to the AP MLD, to indicate whether to perform the transmission over the secondary link, to notify the AP MLD that the secondary link is required to be used for the transmission. The AP MLD wakes the affiliated AP2, or remains the operating state of the affiliated AP2 in the wake state or the active state. In this way, a situation is avoided in which the AP MLD performs transmission over the two links, while the AP2 remains in the sleeping state.

Regarding the AP MLD, no matter which energy-saving mode the AP MLD is in, a process of the affiliate AP1 of the AP MLD transmitting the Beacon frame would not be affected.

The above-mentioned four kinds of energy-saving states would be described as follows.

In the energy-saving state 1, the AP1 is always in the active state, and the AP2 is always in the sleeping state.

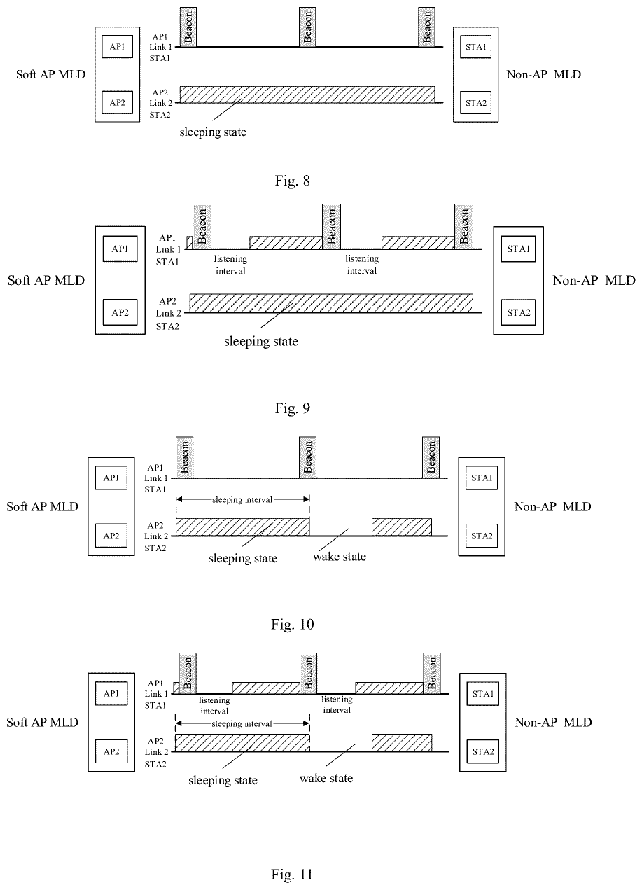

As illustrated in FIG. 8, the AP1 is always in the active state and may transmit the Beacon frame normally. The AP2 remains in the sleeping state for better energy saving if no wake-triggering event occurs. At this point, the energy-saving gains of the AP MLD come from the sleeping state of the AP2.

In the energy-saving state 2, the AP1 is always in the active state, and the AP2 is in the energy-saving mode 1.

As illustrated in FIG. 9, the AP1 is in the energy-saving mode based on the implicit listening interval. The AP1 is waked when a Beacon frame is to be sent, and keeps in the listening state for a period of time after the Beacon frame has been sent. If an uplink transmission request or a downlink transmission request from the Non-AP MLD arrives, the AP1 would remain in a normal mode for a period of time for performing frame exchange. After the frame exchange sequence is completed, the AP1 returns to the sleeping state. The AP2 remains in the sleeping state for better energy saving if no wake event occurs. At this point, the energy-saving gains of the AP MLD come from the fact that the AP1 and the AP2 are each in the sleeping state.

In the energy-saving state 3, the AP1 is always in the energy-saving mode 2, and the AP2 is always in the sleeping state.

As illustrated in FIG. 10, the AP1 is always in the active state, and may transmit the Beacon frame normally. The AP2 is in some kind of energy-saving mode. In the current 802.11 standard, typical energy-saving mechanisms include the baseline energy-saving mode, the TWT etc. At this point, the energy-saving gains of the AP MLD comes from the energy-saving gain generated by the energy-saving mode in which the AP2 is in.

The two energy-saving modes including the baseline energy-saving mode and the TWT are composed of the sleeping state and the active state, which can be extracted as the energy-saving state as illustrated by the AP2 in FIG. 10.

In the baseline energy-saving mode, the state of the STA consists of an energy-saving state and the active state. The STA is waked at a fixed frequency to receive the Beacon frame, and to check whether the AP has buffered traffic for it, or whether there is group-addressed traffic waiting to be transmitted. A life cycle of the traffic buffered by the AP for the STA is not shorter than the listening interval of the STA. When the AP has buffered traffic for the STA or has group-addressed traffic waiting to be sent, the STA transmits a PS-Poll for requesting a traffic transmission, and the AP responds with a DL PPDU. The data transmission is accomplished through a plurality of frame exchanges between the STA and the AP such as the PS-Poll and the DL PPDU. Whenever the AP transmits data to the STA, the AP may use a More Data field of the data frame to indicate whether there are more data frames waiting to be sent, and the STA enters the energy-saving state only after it has received all the data.

In the TWT, the STA is assigned a specific service period (SP) for frame exchange through negotiation with the AP. At the arrival of the SP, it is required that the STA is in the wake state. During a non-SP period, the STA may be in the sleeping state to save energy.

In the WNM sleeping state, the STA does not expect to receive group-addressed traffic, and receives a DTIM frame only after a waiting interval including a plurality of DTIM frames. In other words, the STA waits for a plurality of DTIM frames before receiving one DTIM frame. The waiting interval is referred to as a WNM sleeping interval. The waiting interval is set as a multiple of an individual DTIM interval. While the STA in the baseline energy-saving mode needs to be waked to receive each DTIM frame. In contrast, the WNM sleeping state may allow the STA to sleep for a longer time period, and this mode may set a traffic filtering rule to receive particular traffic.

In addition, all the above-mentioned energy-saving modes may be enhanced by using APSD. The APSD is a mechanism by which the AP transmits buffered downlink traffic to the STA in the energy-saving mode. The APSD is an improvement of the baseline energy-saving mode. In the baseline energy-saving mode, the STA needs to perform poll for each DL PPDU by transmitting a PS-Poll frame. If the downlink data volume is relatively large, the PS-Poll frames may occupy a lot of transmission resources. While the APSD is adopted, the STA no longer needs to transmit the PS-Poll frame, and the data transmission between the AP and the STA is completed by a plurality of exchanging frames such as the DL PPDUs and the BAs, thereby improving the transmission efficiency. There are two forms of APSDs: an Unscheduled APSD (U-APSD) and a Scheduled APSD (S-APSD).

The unscheduled SP starts when the AP receives a Trigger frame from the STA, and ends after the AP has transmitted at least one buffered unit to the STA.

In the Scheduled APSD (S-APSD), a pre-negotiated SP is established between the AP and the STA. The data transmission is performed during the SP. The AP ends the SP by setting the End of Service Period (EOSP) of the last frame within the SP as 1. For the above-mentioned three kinds of energy-saving modes, regardless of which mode the AP2 is in and whether the APSD is used for enhancing, the energy-saving state consists of the sleeping state and the active state. The wake mechanism described below would not be affected. This is because the wake mechanism is configured to avoid a situation where the secondary link is to be used for transmission but the AP2 is still sleeping.

In the energy-saving state 4, the AP1 is always in the energy-saving mode 2, and the AP2 is in the energy-saving mode 1.

As illustrated in FIG. 11, the AP1 is in the energy-saving mode based on the implicit listening interval. The AP1 is waked when the Beacon frame requires to be sent, and keeps in the listening state for a period of time. If the uplink transmission request or the downlink transmission request from the Non-AP MLD arrives, the AP1 would remain in the normal mode for a period of time for frame exchange, i.e., the data transmission. After the frame exchange sequence is completed, the AP1 returns to the sleeping state. The AP2 is in some kind of energy-saving mode. In the current 802.11 standard, typical energy-saving mechanisms are the baseline energy-saving mode, the TWT sleeping state, etc. More detailed information is disclosed in the related description in the AP MLD energy-saving mode 3. At this point, the energy-saving gains of the AP MLD comes from the energy-saving gains generated by the energy-saving mode in which the AP1 and the AP2 are in.

When the AP MLD is in the energy-saving state, the AP1 affiliated with the AP MLD operates over the primary link and is responsible for transmitting the Beacon frame. When the AP1 exchanges frames with the STA1 affiliated with the Non-AP MLD, the AP2 is in the sleeping state at the same time. If the link 2 is wished to be used for data transmission to enhance transmission throughput, a reasonable wake mechanism is required to wake the AP2 at a proper time point. If the wake time point is relatively early, then the energy-saving gains would be reduced. If the wake time point is relatively late, then the data transmission would be affected. Since the uplink data transmission and the downlink data transmission are initiated in different ways, the wireless communication method provided according to embodiments of the present disclosure provides an implicit wake mechanism for the downlink transmission and an explicit wake mechanism for the uplink transmission.

According to embodiments of the present disclosure, the wireless communication method is provided. For the energy-saving problem of the AP MLD, the method provides a mechanism for waking the affiliate AP over the secondary link. In the method, the wake mechanisms in the downlink data transmission scenario and the uplink data transmission scenario are considered respectively, it is ensured that the affiliate AP over the secondary link is timely waked when there is a data transmission over the secondary link. At the same time, the sleeping time duration of the affiliated AP over the secondary link may be increased as much as possible, thereby saving the energy consumption of the Soft APs.

In the related art, the energy-saving problems of the Non-AP MLDs are concerned, while the energy-saving requirements of the AP MLDs may be ignored. The wireless communication method provided according to embodiments of the present disclosure is concerned with energy-saving problems of the AP MLDs. Whichever is the energy-saving modes adopted by the Non-AP MLD associated to the AP MLD, the wireless communication method provided according to the present disclosure is not affected. The method also supports the AP MLD to negotiate its energy-saving mode with a normal Non-AP MLD as an AP MLD associated with the normal Non-AP MLD.

In the following, the wireless communication method provided by embodiments of the present disclosure is illustrated by different examples in the downlink data transmission scenario and the uplink data transmission scenario, respectively.

### Downlink Data Transmission Scenario

When the Non-AP MLD is associated with the AP MLD, the AP MLD would assign an Association ID (AID) to that Non-AP MLD. The AID of the Non-AP MLD corresponds to a bit of the partial virtual bitmap field of the traffic indication message (TIM) element of the Beacon frame sent by the AP MLD.

When the AP MLD has buffered the traffic for the Non-AP MLD, the AP MLD would set the bit of the partial virtual bitmap field of the TIM element that corresponds to the AID of the Non-AP MLD as 1, and the TIM element would be included in the Beacon frame for broadcast. When the Non-AP MLD receives this Beacon frame, the Non-AP MLD would check whether the bit of the TIM element corresponding itself is set. If the bit is set, then the Non-AP MLD would transmit a PS-Poll frame to the AP MLD for requesting a downlink data transmission. In response to receiving the PS-Poll frame, the AP MLD performs the downlink data transmission. The PS Poll frame is configured to request the traffic from the AP, the traffic is buffered when the STA is in the sleeping state. The PS Poll frame includes a frame control field, an AID field, a basic service BSSID field, a transmitting-address or receiver address RA field, and a frame check field. The length of the PS-Poll frame is 20 bytes. The transmitting-address field includes the AID information of the Non-AP MLD.

In 802.11be, to achieve a design goal of a very high throughput, the multi-link technology may be adopted. That is, a single traffic may be transmitted over multiple links. The 802.11be sets up an available link set for the traffic based on the TID-to-link mapping. The default configuration is that, all TIDs are mapped to all links. In other words, the Non-AP MLD may wake the affiliated STAs corresponding to any link in the link set to receive the traffic. During the link-establishing phase, the AP MLD and the Non-AP MLD may also establish different TID-to-link mapping modes through TID-to-link mapping negotiation. For example, a part of the TIDs are mapped to a part of the links. The 802.11be has introduced a multi-link traffic element (MLTE) in the Draft 1.0 version for traffic indication. An indication bit of the virtual bitmap field of the TIM element corresponds to the AID of a Non-AP MLD, and also corresponds to a multi-link traffic indication bitmap of the multi-link traffic element. Three bits of the indication bitmap correspond to three links of a multi-link device. A link-level traffic indication may be performed by setting the corresponding bits in the indication bitmap as 1. The AP MLD performs the link-level traffic indication by setting the TIM element and the multi-link traffic element. Similarly, if the AP MLD knows the AID information of the Non-AP MLD, it may also know whether traffic has been buffered for that Non-AP MLD and which link the buffered traffic is specifically mapped to.

Regarding the downlink data transmission scenario, the wireless communication method provided in embodiments of the present disclosure includes the following two kinds of wake approaches: a wake approach 1 and a wake approach 2.

In the wake approach 1, an implicit wake is performed at the time of constructing the Beacon frame.

In the wake approach 2, an implicit wake is performed based on the received transmission indication frame.

In the following, the two wake approaches are described separately.

In the wake approach 1, an implicit wake is performed at the time of constructing the Beacon frame.

For the sake of illustration, it is assumed that, the AP1 is always in the active state, the AP2 is always in the sleeping state, and the Non-AP MLD is always in the active state. This is the simplest combination of scenarios, but what state each of the AP1, the AP2, and the Non-AP MLD is in has no effect on the wake mechanism.

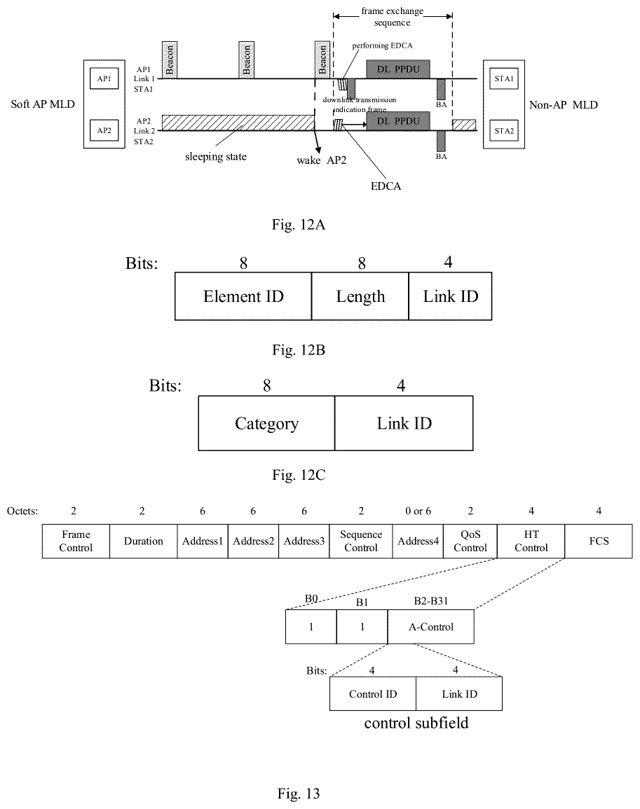

The AP MLD and the Non-AP MLD perform the following operations as illustrated in FIG. 12A.

Operation 1: The AP MLD wakes the AP2 based on the buffered traffic.

The AP MLD sets, based on the buffered traffic, the corresponding bits of the partial virtual bitmap fields in the TIM elements of the Beacon frame as 1, and the AP MLD may know, in conjunction with the TID-to-link mapping of the traffic, whether there is traffic mapped to the secondary link. If at this point, there is traffic mapped to the secondary link, it is indicated that, the secondary link may be used for subsequent data transmission, the AP2 is then waked to prepare for the downlink data transmission that would take place.

In the 802.11 standard, the individual-addressed traffic is indicated by the TIM element, while the group-addressed traffic is indicated by the DTIM element. If the group-addressed traffic waiting to be sent exists in the AP MLD, it is indicated by setting the bit 0 of the bitmap control field of the DTIM element as 1. Therefore, if the group-addressed traffic waiting to be sent is found when the Beacon frame is constructed, then the AP2 would also be waked.

The Beacon frame may also carry a state indication message, namely the sixth indication message, for indicating a wake result of the AP2. The implementation approach of the state indication message includes the following two approaches: an implementation approach 1 and an implementation approach 2.

In the implementation approach 1, a corresponding indication element is added in the Beacon frame.

As illustrated in FIG. 12B, the indication element includes an Element ID field, a Length field, and a Link ID field. The Element ID uniquely identifies the element. The Length field indicates a length of the element. A bit at location i of the Link ID field identifies the link i. If the link is a non-primary link, then the Soft AP MLD may set this bit as 1 for indicating to the Soft AP MLD that the AP2 is waked, and set this bit as 0 for indicating that the AP2 is not to be waked. The Link ID field may be replaced with a Link ID Bitmap field. The Link ID Bitmap field has more bits than the Link ID field, and may be configured to indicate more wake results of the affiliated APs operating over the non-primary links. This element may be included in the Beacon frame for indication.

In the implementation approach 2, the Action element is defined in the Beacon frame.

As is illustrated in FIG. 12C, the Action element includes a Category field and the Link ID field. The Category field uniquely identifies the Action element. A bit at location i of the Link ID field identifies the link i. If the link is a non-primary link, then the Soft AP MLD may set this bit as 1 for indicating to the Soft AP MLD that the AP2 is waked, and set this bit as 0 for indicating that the AP2 is not to be waked. The Link ID field may be replaced with the Link ID Bitmap field. The Link ID Bitmap field has more bits than the Link ID field, and may be configured to indicate more wake results of the affiliated APs operating on the non-primary links. This action element packet may be included in the management frame for indication.

Operation 2: after the AP2 is waked, the AP2 may perform the enhanced distributed channel access (EDCA) mechanism over the link 2 immediately, and a backoff counter is decremented to zero. After that, the AP2 keeps the backoff counter at zero according to the multi-link channel access rule of the 802.11be.

Operation 3: in response to receiving the Beacon frame, the Non-AP MLD checks whether the corresponding bit of the TIM element has been set. If the corresponding bit is set, then the downlink transmission indication frame is sent for requesting the downlink data.

The Non-AP MLD may set the Link ID/Link ID Bitmap field of the downlink transmission indication frame according to the state that the affiliated STA2 is in. If the STA2 is in the sleeping state at this point, then the bit of the Link ID field corresponding to the AP2 is set as 0, to indicate to the AP MLD that no wake operation is to be performed on the AP2; and conversely, the bit is set as 1. The bit at location 2 of the Link ID field corresponds to the AP2. If the Non-AP MLD intends to use the AP2 for the subsequent data transmission, then the bit at location 2 of the Link ID field may be set as 1. In this way, it is indicated that, in addition to the AP1, the AP MLD should also use the AP2 for the downlink transmission. The bit being set as 0 indicates that, the AP MLD would not use the AP2 for transmission afterwards, and indicates to the AP MLD not to wake the AP2. At the same time, the Non-AP MLD should also ensure that, the STA2 is able to receive the data normally during data transmission processes afterwards, otherwise the corresponding bit of the Link ID field is not set. Before the downlink transmission indication frame is sent, the STA1 may perform the EDCA to obtain a transmission opportunity, and after the STA1 has obtained the transmission opportunity, the downlink transmission indication frame is sent.

In response to receiving the downlink transmission indication frame, the AP MLD may look up, based on a clue obtained from the value in the transmitting-address field of the downlink transmission indication frame, the AID information of the Non-AP MLD that transmits the downlink transmission indication frame. The AP MLD later decides which traffic should be used for response according to the AID. If this downlink transmission indication frame is a Control Wrapper frame wrapped with or including a PS-Poll frame, then the AID information for the Non-AP MLD may be taken out directly from the ID field of this downlink transmission indication frame. The AP MLD later decides which traffic should be used for response according to the AID.

The downlink transmission indication frame includes the following implementation approaches: the implementation approach 1 and the implementation approach 2.

In the implementation approach 1, the downlink transmission indication frame is implemented by using the QoS-Null frames.

An HT control field of the QoS-Null frame includes three variation fields such as HT, VHT and HE etc. The A-Control field of the HE variant is a control list that includes one or more control fields. Each control field is uniquely identified by a Control ID. In the current standard, values from 7 to 14 are reserved for the Control ID. Any of the reserved values may be used to identify the control fields designed in the present approach. As illustrated in FIG. 13, the newly added control field provides the Link ID field that is configured to indicate the AP MLD to wake the affiliated AP. The Link ID field is a 4-bit field. The Link ID field identifies the affiliated AP of the AP MLD operating over a particular link. For example, a bit at location i identifies the affiliated AP of the AP MLD operating over the link whose Link ID=i. Therefore, it is possible to set the bits of the Link ID field corresponding to the affiliated AP of the AP MLD operating over the secondary link, to indicate that, in addition to the affiliated APs operating over the primary link, which affiliated AP operating over the secondary link should be used by the AP MLD to transmit the downlink data. For example, the bit at the location 1 of the Link ID field corresponds to the affiliated AP of the AP MLD operating over a link whose Link ID=1. Assuming that the link is the secondary link, thus the bit may be set as 1 to indicate the AP MLD to also use that AP for transmission when transmitting the downlink data, and the bit may be set as 0 to indicate that the AP is not used for transmission.

In the FIG. 13, the QoS-Null frame includes: a Frame Control field, a Duration field, an Address 1 field, an Address 2 field, an Address 3 field, a Sequence Control field, an Address 4 field, a QoS Control field, an HT Control field, and a Frame Check Sum (FCS) field.

In the implementation approach 2, the Control Wrapper frame is used to implement the transmission indication frame, and a new Control Subfield, i.e., a Control Field, is added in the Control Wrapper frame to implement the transmission indication frame.

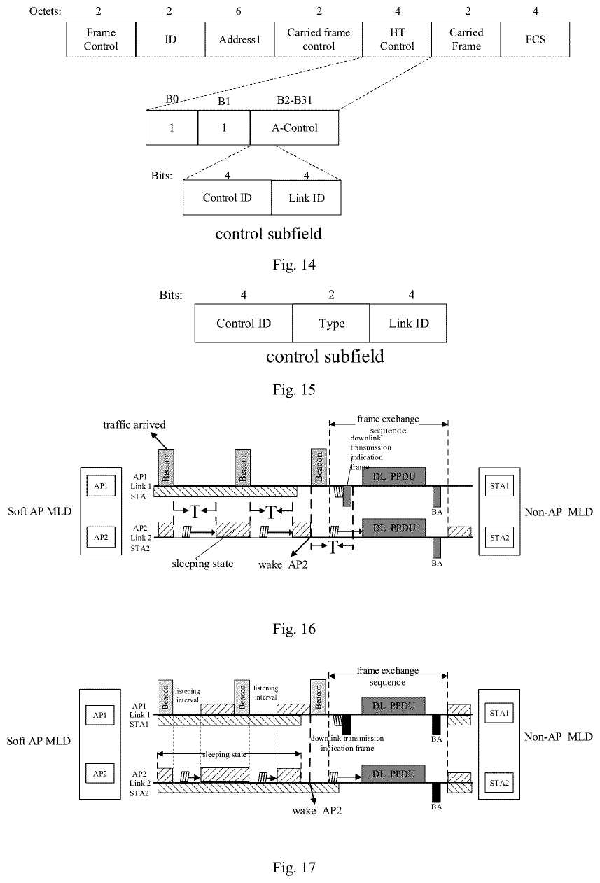

The Control Wrapper frame is used to wrap any other control frames, to provide more information through the wrapping process. As illustrated in FIG. 14, based on such an approach of the Control Wrapper, the PS-Poll frame may be wrapped by the Control Wrapper frame. This is achieved by a way in which: the Frame Control field of the PS-Poll frame is carried by the Carried Frame Control field of the Control Wrapper, and the fields of the PS-Poll frame subsequent to the Address 1 are carried in the Carried Frame field, while the Frame Check Sequence (FCS) field is not included in the Carried Frame field. The AID information of the PS-Poll frame is included in the ID field of the Control Wrapper frame, and the HT control field of the Control Wrapper is configured to provide additional indication message. The HT control field of this frame includes three variation fields such as HT, VHT and HE etc. The A-Control field of the HE variant is a control list that includes one or more control fields. Each control field is uniquely identified by a Control ID. In the current standard, values from 11 to 14 are reserved for the Control ID. Any of the reserved values may be used to identify the control field designed in the present approach. A Link ID field is included in this frame. The Link ID field is configured to indicate that, whether the affiliated AP operating over the secondary link is used by the AP MLD to perform the downlink data transmission. The details and settings of the fields are same to that in the implementation approach 1.

As illustrated in the FIG. 14, the Control Wrapper frame includes: a Frame Control field, an Identification (ID) field, an Address 1 field, a Carried Frame Control field, an HT Control field, a Carried Frame field, and a Frame Check Sum (FCS) field.

Regarding the above-mentioned implementation approach 1 and the implementation approach 2, the format of the control subfield of FIG. 13 and FIG. 14 may also be as illustrated in FIG. 15. The control subfield as illustrated in FIG. 15 includes: a Control Identification (ID) subfield, a Type subfield, and a Link identification (ID) subfield. The Type subfield identifies usage of the control field. If the Type subfield is set as 00, it is identified that, the current frame is used for a wake indication of the AP2 in the case of the downlink transmission. If the Type subfield is set as 01, it is identified that, the current frame is used for a wake indication of the AP2 in the case of the uplink transmission. This control field is included in the downlink transmission indication frame.

Depending on the specific implementation of the downlink transmission indication frame in the implementation approach 1 and the implementation approach 2, the control field may be included in the A-Control subfield of the HT Control field of a QoS-Null frame, or the control field may be included in a Control Wrapper frame in which a PS-Poll frame is wrapped.

For the control fields as illustrated in FIG. 13 to FIG. 15, the Link ID field of the control field may be replaced with a Link ID bitmap field.

In the current 802.11be standard, the MLD architecture is often presented with three links. The Link ID includes 4 bits, and is able to identify all the affiliated APs. Regarding the above-mentioned implementation approach 1 and the implementation approach 2, the possibility that the 802.11be MLD includes more links in the future is not excluded. For this case, the Link ID bitmap field of an extended scheme may be used. The Link ID bitmap field includes more bits, and may indicate more affiliate APs operating over the secondary links.

Operation 4: the AP MLD performs the transmission of the traffic.

Regarding transmission of the group-addressed traffic, if the group-addressed traffic should be transmitted at this point, then the AP MLD directly uses the AP1 and the AP2 for data transmission After the data transmission is completed, the AP2 returns to the sleeping state.

Regarding transmission of the individually-addressed traffic, after the downlink transmission indication frame from the Non-AP MLD is received by the AP MLD, the AP MLD determines, based jointly on the link mapping information of the traffic buffered for the Non-AP MLD and the Link ID field of the transmission indication frame, which links to be used to transmit the downlink data. If the traffic buffered for the Non-AP MLD is not mapped to the secondary link, then regardless of how the Link ID field is set, the AP1 is used to transmit the downlink data, while the AP2 is rendered to return to the sleeping state. If the traffic buffered for the Non-AP MLD is mapped to the secondary link, then the Link ID field is checked to learn whether the Non-AP MLD has requested using the AP2. If the Non-AP MLD has requested using the AP2, then later the AP1 and the AP2 are used for synchronized transmission of the downlink data. If the Non-AP MLD hasn't requested using the AP2, then the AP1 is used for transmission of the downlink data, and the AP2 is rendered to return to the sleeping state.

When the AP MLD uses two links for the data transmission, since the AP2 has finished the backoff process, thus the AP1 and the AP2 may perform the synchronized transmission of the downlink data. After the frame exchange sequence is completed, the AP2 returns to the sleeping state. If only one link is used, then the AP2 directly returns to the sleeping state without waiting for the frame exchange sequence to be completed, and the AP1 is used to complete the frame exchange sequence.

The above-mentioned wireless communication method may be implemented as the following embodiment 1 or embodiment 2.

The embodiment 1 relates to implicit wake with timeout return.

For the sake of illustration, it is assumed that, the AP1 is always in the active state, the AP2 is always in the sleeping state, and the Non-AP MLD is always in the active state. This is the simplest combination of scenarios, but whichever state each of the AP1, the AP2, and the Non-AP MLD is in does not affect the wake mechanism.

When the traffic arrives earlier, the AP1 indicates the traffic in the TIM element. If there is traffic mapped to the link 2, then the AP2 is waked. However, the affiliated STA1 of the Non-AP MLD may be in the sleeping state at this point. As illustrated in FIG. 16, the STA1 is in the sleeping state before the third Beacon frame is sent by the AP1. Even if the AP2 is waked, the data transmission would not be performed. Until the third Beacon frame is sent, the AP MLD receives the downlink transmission indication frame from the Non-AP MLD. A Link ID field is contained in the downlink transmission indication frame. Subsequently, the AP MLD determines, based on the Link ID field, whether to wake the Link 2 (the secondary link) for the downlink data transmission. After the data transmission is completed, the AP2 returns to the sleeping state. However, in the previous two wake processes, there was no specific timing for the AP2 to return to the sleeping state. Considering these two factors, after the AP2 is waked, a timer is set. If the AP MLD does not receive the transmission indication frame from the Non-AP MLD within a time threshold T, then the AP2 automatically returns to the sleeping state.

The AP MLD and the Non-AP MLD perform the following operations as illustrated in FIG. 12.

Operation 1: the AP MLD wakes the AP2 based on the buffered traffic.

The AP MLD sets, based on the buffered traffic, the corresponding bits of the partial virtual bitmap field of the TIM element of the Beacon frame as 1, and the AP MLD may know, in conjunction with the TID-to-link mapping of the traffic, whether there is traffic mapped to the secondary link. If there is traffic mapped to the secondary link at this point, then it is indicated that, the secondary link may be used for subsequent data transmission, the AP2 is then waked to prepare for the downlink data transmission that will take place.

In the 802.11 standard, the individually-addressed traffic is indicated by the TIM element, while the group-addressed traffic is indicated by the DTIM element. When the group-addressed traffic waiting to be sent exists in the AP MLD, it is indicated by setting the bit 0 of the bitmap control field of the DTIM element as 1. Therefore, if the group-addressed traffic waiting to be transmitted is found when constructing the Beacon frame, then the AP2 would also be waked.

After the AP2 is waked by the AP MLD, the designed timer is triggered to commence counting.

Operation 2: after being waked, the AP2 performs the EDCA mechanism over the link 2 immediately, and the backoff counter is decremented to zero. After that, the AP2 keeps the backoff counter at zero according to the multi-link channel access rule of 802.11be.

Operation 3: In response to receiving the Beacon frame, the Non-AP MLD checks whether the corresponding bit of the TIM element has been set. If the corresponding bit is set, then the downlink transmission indication frame is sent for requesting downlink data.

The Non-AP MLD may correspondingly set the Link ID/Link ID Bitmap field of the downlink transmission indication frame according to the state that the STA2 is now in. If the STA2 is in the sleeping state at this time point, then the bit of the Link ID field corresponding to the AP2 is set as 0, to indicate to the AP MLD that no wake operation is to be performed on the AP2; and conversely, the bit is set as 1. The bit at the location 2 of the Link ID field corresponds to the AP2. If the Non-AP MLD intends to use the AP2 for the subsequent data transmission, then the bit at the location 2 of the Link ID field may be set as 1. In this way, it is indicated that, the AP MLD should also use the AP2 for the downlink transmission in addition to the AP1. The bit being set as 0 indicates that, the AP MLD would not employ the AP2 for transmission afterwards, and indicates to the AP MLD not to wake the AP2. At the same time, the Non-AP MLD should also ensure that, the STA2 is able to receive data normally during the data transmission processes afterwards, otherwise the corresponding bit of the Link ID field is not set.

In response to receiving this downlink transmission indication frame, the AP MLD may look up, based on a clue obtained from the value in the transmitting-address field of the downlink transmission indication frame, the AID information of the Non-AP MLD that transmits the downlink transmission indication frame. If this downlink transmission indication frame is a Control Wrapper frame wrapped with a PS-Poll frame, then the AID information for the Non-AP MLD may be taken out directly from the ID field of this downlink transmission indication frame. The AP MLD later decides which traffic should be used for response according to the AID.

Operation 4: the AP MLD performs the transmission of the traffic.

Regarding transmission of the group-addressed traffic, if the group-addressed traffic should be transmitted at this point, then the AP MLD directly uses the AP1 and the AP2 for data transmission. After the data transmission is completed, the AP2 returns to the sleeping state.

Regarding transmission of the individually-addressed traffic, if within a time threshold T after the AP1 starts counting, no downlink traffic request frame is received from the STA1, then the AP2 would automatically return to the sleeping state. If the downlink traffic request frame is received from the Non-AP MLD, then the AP MLD determines, based jointly on the link mapping information of the traffic buffered for the Non-AP MLD and the Link ID field of the transmission indication frame, which links to be used to transmit the downlink data. If the traffic buffered for the Non-AP MLD is not mapped to the secondary link, then regardless how the Link ID field is set, the AP1 is used to transmit the downlink data, while the AP2 is rendered to return to the sleeping state. If the traffic buffered for the Non-AP MLD is mapped to the secondary link, then the Link ID field is checked to learn whether the Non-AP MLD has requested using the AP2. If the Non-AP MLD has requested using the AP2, then the AP1 and the AP2 are later used for the synchronized transmission of the downlink data. If the Non-AP MLD hasn't requested using the AP2, then the AP1 is used for transmission of the downlink data, and the AP2 is rendered to return to the sleeping state.

When the AP MLD uses two links for the data transmission, since the AP2 has finished the backoff process, thus the AP1 and the AP2 may perform the synchronized transmission of the downlink data. After the frame exchange sequence is completed, the AP2 returns to the sleeping state. If only one link is used, then the AP2 directly returns to the sleeping state without waiting for the frame exchange sequence to be completed, and the AP1 is used to complete the frame exchange sequence.

### The Embodiment 2

In the embodiment 2, the energy-saving aspects of the AP1, the AP2, and the Non-AP MLD are considered.

When the Beacon frame is constructed for implicit wake, the energy-saving mode of each of the affiliated AP1 and the affiliated AP2 of the AP MLD, and Non-AP MLD are considered. The AP1 may remain in the active state or in the energy-saving mode based on the implicit listening interval. The case in which the AP1 remains in the active state is the simplest case. The AP2 may remain in the sleeping state or a certain energy-saving mode, such as the TWT energy-saving mode and the baseline energy-saving mode. In the latest 802.11be standard-Draft 1.1, the only energy-saving mode for the Non-AP MLD is the WNM mode. In the WNM mode, the sleeping states of various affiliated STAs of the Non-AP MLD are synchronized. In other words, the various affiliated STAs of the Non-AP MLD enter and wake from the sleeping state simultaneously. However, the standard also recites that, various affiliated STAs of the multi-link device may have independent energy-saving states and need not to be synchronized. The independent energy-saving state is also more complex than the WNM. Therefore, in the embodiment 2, the affiliated STA of the Non-AP MLD is illustrated as being in an independent energy-saving state.

It is assumed that, the AP1 is in an energy-saving mode based on the implicit listening interval. The AP2 is in a certain energy-saving mode whose operating state consists of the wake state and the sleeping state. Whichever energy-saving mode the AP2 is in, the processes of the embodiments and the wake mechanisms are not affected. The affiliated STAs of the Non-AP MLD are in independent energy-saving states. In this mode, because the AP1 has an active listening interval, the AP1 would return to the sleeping state if it does not receive the downlink data transmission request or the uplink data transmission from the Non-AP MLD during the listening interval. Therefore, it is not necessary to set a timer in the embodiment 2.

The AP MLD and the Non-AP MLD perform the following operations as illustrated in FIG. 17.

Operation 1: the AP MLD wakes the AP2 based on the buffered traffic.

The AP MLD is waked at a time point when it is scheduled to transmit the Beacon frame. The AP MLD sets, based on the buffered traffic, the corresponding bits of the partial virtual bitmap field in the TIM element of the Beacon frame as 1. The AP MLD may know, in conjunction with the TID-to-link mapping of the traffic, whether there is traffic mapped to the secondary link. If at this time point, there is traffic mapped to the secondary link, then it is indicated that, the secondary link may be used for subsequent data transmission. The AP2 is then waked to prepare for the downlink data transmission that will take place.

If there is group-addressed traffic waiting to be transmit, then the AP2 may also be waked. When being waked, the AP2 may be in the wake state, then the AP2 remains in the wake state. After the AP1 has sent the Beacon frame, the AP1 actively listens for a time period. The AP1 returns to the sleeping state if the downlink traffic request from the Non-AP MLD is not received within that time period. If the AP2 is waked, then the AP2 may also be rendered to return to the sleeping state at the same time. Since the AP1 has entered the sleeping state, the Link 1 (the primary link) is unavailable, then the link 2 (the secondary link) must be unavailable. If the downlink data traffic request frame from the Non-AP MLD is received during the listening interval, then jump to an operation 4.

Operation 2: after the AP2 is waked, it may perform the EDCA mechanism over the link 2 immediately, and the backoff counter is decremented to zero. After that, the AP2 keeps the backoff counter at zero according to the multi-link channel access rule of 802.11be.

A case where the backoff process is successful but the AP2 is returned to the sleeping state would not cause the change of parameters when the AP2 enters the EDCA next time. The parameters may be for example a backoff window size and a QoS short retransmission counter. At the end of a listening interval, the operating state of the AP2 keeps the same as that of the AP1, regardless of whether the AP2 has backoff successfully.

Operation 3: when switching from the sleeping state to the wake state, the STA1 would first receive the Beacon frames for traffic checking.

In response to receiving the Beacon frame, the STA1 checks whether the corresponding bit of the TIM element has been set. If the corresponding bit is set, then the downlink transmission indication frame is sent for requesting downlink data. The Link ID/Link ID Bitmap field of the downlink transmission indication frame may be correspondingly set according to the state that the STA2 is now in. If the STA2 is in the sleeping state at this time point, then the bit of the Link ID field corresponding to the AP2 is set as 0, to indicate to the AP MLD that no wake operation is to be performed on the AP2; and conversely, the bit is set as 1. The bit at the location 2 of the Link ID field corresponds to the AP2. If the Non-AP MLD intends to use the AP2 for the subsequent data transmission, then the bit at location 2 of the Link ID field may be set as 1. In this way, it is indicated that, the AP MLD should also employ the AP2 for the downlink transmission in addition to the AP1. The bit being set as 0 indicates that, the AP MLD would not employ the AP2 for transmission afterwards, and indicates to the AP MLD not to wake the AP2. At the same time, if the corresponding bit of the Link ID field is not set, then the Non-AP MLD should ensure that, the STA2 is able to receive data normally during the data transmission processes afterwards, otherwise the corresponding bit of the Link ID field is not set.

In response to receiving this frame, the AP MLD may look up, based on a clue obtained from the value in the transmitting-address field of the frame, the AID information of the STA MLD that sent this transmission indication frame. The AP MLD later decides which traffic should be used for response according to the AID. If this wake indication frame is realized by wrapping the PS-Poll frame, then the AID information of the Non-AP MLD may be obtained directly through the ID field of the frame.

Operation 4, the AP MLD performs the transmission of the traffic.

Regarding transmission of the group-addressed traffic, if the group-addressed traffic should be transmitted at such a listening interval, then the AP1 and the AP2 may be directly used for the data transmission. After the data transmission is completed, the AP1 and the AP2 return to the sleeping state.

Regarding transmission of the individually-addressed traffic, if within a listening interval of the AP1, no downlink transmission indication frame is received from the STA1, then the AP1 and the AP2 would automatically return to the sleeping state. If the downlink transmission indication frame is received from the STA1, then the AP MLD may determine, based jointly on the link mapping information of the traffic buffered for the Non-AP MLD and the Link ID field of the transmission indication frame, which links to be used to transmit the downlink data. If the traffic buffered for the Non-AP MLD is not mapped to the secondary link, then regardless how the Link ID field is set, the affiliated AP operating over the primary link is used to transmit the downlink data, while the AP2 is rendered to return to the sleeping state. If the traffic buffered for the Non-AP MLD is mapped to the secondary link, then the Link ID field is checked to learn whether the Non-AP MLD has requested using the AP2. If the Non-AP MLD has requested using the AP2, then later the AP1 and the AP2 are used for the synchronized transmission of the downlink data. If the Non-AP MLD hasn't requested using the AP2, then the AP1 is used for transmission of the downlink data, and the AP2 is rendered to return to the sleeping state.

When the AP MLD uses two links for the data transmission, since the AP2 has finished the backoff process, thus the AP1 and the AP2 may perform the synchronized transmission of the downlink data. After the frame exchange sequence is completed, the AP2 returns to the sleeping state. If only one link is used, the AP2 directly returns to the sleeping state without waiting for the frame exchange sequence to be completed, and the AP1 is used to complete the frame exchange sequence. After the frame exchange sequence is completed, the AP1, the AP2 (if waked), the STA1, and the STA2 (if participating in the transmission) would return to the sleeping state.

In the wake approach 2, the implicit wake is performed based on the received transmission indication frame.

In both the embodiment 1 and the embodiment 2, there are useless wakes of the AP2, which results in reduced energy-saving gains. Yet these wakes are necessary, because the AP MLD does not know whether the state of the STA1 is the sleeping state or the active state. It is considered that the transmission indication frame sent by the Non-AP MLD includes the Link ID field. The Link ID field indicates that the Non-AP MLD has requested to use an affiliated AP operating over the secondary link. The AP MLD may learn, based on this transmission indication frame, that the AID information of the Non-AP MLD, and thus know which of the buffered traffic in the cache should be used for response and the link mapping relationship of such traffic. The AP MLD may determine, based on the link mapping relationship of the buffered traffic requested, whether to wake the AP2 operating over the secondary link. The AP1 is expected to respond with the data frame within an SIFS time period after receiving the transmission indication frame. If two links are to be used for the data transmission, then the AP2 is unlikely to complete the backoff process within such an SIFS time period. This leads to an affection that subsequent synchronized transmissions cannot be performed normally either. This is because when the AP1 transmits the first PPDU, the AP2 has not completed the backoff process, and it is impossible to begin the PPDU alignment. For this reason, the AP1 should respond with an Ack frame after receiving the downlink traffic request frame. After that, the AP1 and the AP2 perform the backoff process. Any one of the AP1 and the AP2 that backs off to zero first keeps the backoff counter at 0 according to the multi-link channel access rule of the 802.11be, and waits for the other one of the AP1 and the AP2 to complete its backoff before the synchronization transmission of the downlink data may be performed.

But the above-mentioned process does not apply to the group-addressed traffic. The TIM element is configured to indicate the individually-addressed traffic. The DTIM element is configured to indicate the group-addressed traffic. Whenever several TIM elements are sent, the next TIM element would become the DTIM element. The DTIM element indicates performance of the group-addressed traffic. The DTIM Count field of the TIM element indicates that, how many Beacon frames are present before the next DTIM element. The TIM element is included in the Beacon frame. When the value of the DTIM Count field is 0, it is indicated that the current TIM element is a DTIM element. When there is the group-addressed traffic, the bit0 of the Bitmap Control field of the current element is set as 1, to indicate this group-addressed traffic. For the above-mentioned indication of the group-addressed traffic, in the embodiment 1 and the embodiment 2, the approach of implicitly waking at the time of constructing the Beacon frame is applicable for both the individually-addressed traffic and the group-addressed traffic. This is because, by this approach, it is possible to know whether there is an individually-addressed traffic mapped to the secondary link at the AP and whether there is a group-addressed traffic waiting to be sent. However, based on the AID information of the transmission indication frame sent by the Non-AP MLD, it is not possible to determine whether there is a group-addressed traffic waiting to be sent, therefore, this approach is valid for the individually-addressed traffic, but not valid for the group-addressed traffic. Thus, whether to wake the AP2 is determined based on two conditions: the AID information of the Non-AP MLD and whether there is a group-addressed traffic waiting to be transmit at the AP MLD. As long as one of the two conditions is valid, the AP2 is to be waked.

### An Embodiment 3

For the sake of illustration, it is assumed that, the AP1 is always in the active state, the AP2 is always in the sleeping state, and the Non-AP MLD is always in the active state. This is the simplest combination of scenarios, but what states each of the AP1, the AP2, and the Non-AP MLD is in has no influence on the wake mechanism.

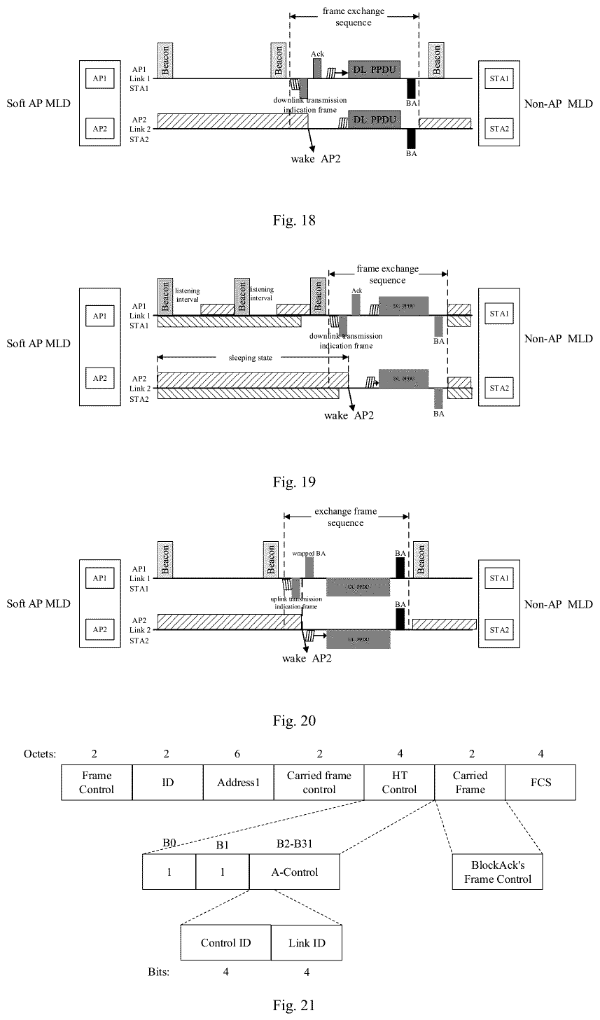

The AP MLD and the Non-AP MLD perform the following operations as illustrated in FIG. 18.

Operation 1: the AP MLD sets, based on the buffered traffic, the corresponding bit of the partial virtual bitmap field of the TIM element of the Beacon frame as 1. After the setting process is completed, the Beacon frame is sent by the AP1.

Operation 2: the Non-AP MLD transmits the downlink transmission indication frame to the AP MLD.

In response to receiving the Beacon frame, the affiliated STA1 of the Non-AP MLD checks whether the corresponding bit of the TIM element has been set. If the corresponding bit is set, then the downlink transmission indication frame is sent for requesting the downlink data. A Link ID field is included in the downlink transmission indication frame. One bit in this Link ID field corresponds to one affiliated AP value of an AP MLD. For example, the bit at the location i identifies the affiliated AP of the AP MLD operating over the link of which Link ID=i. If the Non-AP MLD wishes the AP MLD to use the AP2 to perform the transmission during the subsequent data transmission, then the Non-AP MLD would indicate this wish by setting the bit of the Link ID field that corresponds to the AP2. At the same time, the Non-AP MLD should also ensure that, the corresponding affiliated STA of the Non-AP MLD is able to receive data normally during the data transmission processes afterwards, otherwise the corresponding bit of the Link ID field is not set. For example, the bit at location 2 of the Link ID field corresponds to the AP2. If the STA MLD intends to use the AP2 for the subsequent data transmission, then the bit at location 2 of the Link ID field may be set as 1. In this way, it is indicated that, the AP MLD should also use the AP2 for downlink transmission in addition to the AP1. The bit at the location 2 of the Link ID field may be set as 0, to indicate that the AP MLD would not use the AP2 for transmission afterwards.

Operation 3, the AP MLD wakes the AP2.

For the transmission of the group-addressed traffic, if the group-addressed traffic should be sent at this time point, then the AP2 is waked directly. Then jump to the operation 4.

For the transmission of the individually-addressed traffic, in response to receiving the downlink transmission indication frame from the Non-AP MLD, the AP MLD may look up, based on the value in the transmitting-address field of the transmission indication frame, the AID information of the Non-AP MLD. After the AID information is obtained, if this downlink transmission indication frame is a Control Wrapper frame wrapped with a PS-Poll frame, then the AID information for the Non-AP MLD may be taken out directly from the ID field of this downlink transmission indication frame. The AP MLD later decides which traffic should be used for response according to the AID. Then the AP MLD may determine, based jointly on the link mapping information of the traffic buffered for the Non-AP MLD and the Link ID field of the transmission indication frame, which links to be used to transmit the downlink data. At the same time, the AP MLD replies with the Ack frame. If the traffic buffered for the Non-AP MLD is not mapped to the secondary link, then regardless how the Link ID field is set, only the AP1 is used to transmit the downlink data. If the traffic buffered for the Non-AP MLD is mapped to the secondary link, then the Link ID field is checked to learn whether the Non-AP MLD has requested using the AP2. If the Non-AP MLD has requested using the AP2, then the AP2 is waked. When the AP2 is waked, the AP2 may also just be in the wake state, then the AP2 keeps in the wake state until the end of the frame exchange sequence.

Operation 4: the AP1 performs the EDCA mechanism over the first link, and the AP2 performs the EDCA mechanism over the second link.

The AP1 performs the EDCA mechanism over the first link (the primary link), and the AP2 performs the EDCA mechanism over the second link (the secondary link). The backoff counters are decremented to zero. To ensure the synchronized transmission of the downlink data between the AP1 and the AP2, any one of the first AP and the second AP that backs off to zero first would keep its backoff counter at zero according to the multi-link channel access rule of the 802.11be, and wait for another one of the first AP and the second AP to complete its backoff process before the synchronization transmission of the downlink data may be performed. If the AP2 is not used, then the AP1 would be used to transmit the downlink data.

The above-mentioned embodiments 1 and 3 are compared as follows.

In the embodiment 1, the implicit wake is performed when the Beacon frame is constructed. While in the embodiment 3, the implicit wake is performed based on the transmission indication frame sent by the affiliated STA of the Non-AP MLD. The advantage of the embodiment 1 is that: the AP2 operating over the secondary link is waked immediately when the Beacon frame indicates that there is traffic mapped to the secondary link or that there is the group-addressed traffic, and the secondary link is available at an early time. The disadvantage of the embodiment 1 is that: the AP2 operating over the secondary link is waked as soon as there is traffic mapped to the secondary link in the Beacon frame, while at this time, the affiliated STA of the Non-AP MLD may be in the sleeping state, thereby reducing the energy-saving gains. The advantage of the embodiment 3 is that: whether the AP2 is to be waked is determined jointly based on the transmission indication frames sent by the affiliated STA of the Non-AP MLD and whether there is a group-addressed traffic waiting to be sent, thereby avoiding invalid wake, and increasing the energy-saving gains. However, the disadvantage of the embodiment 3 is that, the timing when the secondary link is available is later than that in the embodiment 1.

### An Embodiment 4

During the process of performing the implicit wake in response to receiving the transmission indication frame, the energy-saving modes in which the three of the affiliated AP1 and the affiliated AP2 of the AP MLD and the Non-AP MLD are in are considered. The AP1 may remain in the active state or in the energy-saving mode based on the implicit listening interval. The case in which the AP1 remains in the active state is the simplest case. The AP2 may remain in the sleeping state or a certain energy-saving mode, such as the TWT energy-saving mode and the baseline energy-saving mode. In the latest 802.11be standard Draft 1.1, the only energy-saving mode for the Non-AP MLD is the WNM mode. In the WNM mode, the sleeping states of various affiliated STAs of the Non-AP MLD are synchronized. Various affiliated STAs of the Non-AP MLD enter and wake from the sleeping state simultaneously. However, the standard also recites that, the various affiliated STAs of a multi-link device may have independent energy-saving states and need not be synchronized. The independent energy-saving state is also more complex than the WNM. Therefore, in the embodiment 4, the affiliated STA of the Non-AP MLD is illustrated as being in an independent energy-saving state.

It is assumed that, the AP1 is in the energy-saving mode based on the implicit listening interval. The AP2 is in a certain energy-saving mode whose operating state consists of the sleeping state and the wake state. Whichever energy-saving mode the AP2 is in, the processes of the embodiments and the wake mechanism are not affected. The affiliated STAs of the Non-AP MLD are in an independent energy-saving states. In this mode, because the AP1 has the active listening interval, the AP1 would return to the sleeping state if it does not receive the downlink data transmission request or the uplink data transmission request from the Non-AP MLD during the listening interval.

The AP MLD and the Non-AP MLD perform the following operations as illustrated in FIG. 19.

Operation 1: The AP MLD is waked at a time point when it is scheduled to transmit the Beacon frame. The AP MLD further transmits the Beacon frame to the Non-AP MLD.

The AP MLD is waked at a time point when it is scheduled to transmit the Beacon frame. The AP MLD sets, based on the buffered traffic, the corresponding bit of the partial virtual bitmap field in the TIM element of the Beacon frame as 1. After the setting process is completed, the AP1 transmits the Beacon frame and keeps in the listening state for a period of time. If no downlink traffic request is received from the Non-AP MLD during this listen interval, then the AP1 returns to the sleeping state. If the downlink data traffic request from the Non-AP MLD is received during the listening interval, then jump to the operation 4.

Operation 2: the Non-AP MLD returns the downlink transmission indication frame to the AP MLD.

When switching from the sleeping state to the wake state, the STA1 would first receive the Beacon frame for traffic checking.

In response to receiving the Beacon frame, the STA1 checks whether the corresponding bit of the TIM element has been set. If the corresponding bit is set, then the transmission indication frame is sent for requesting the downlink data. A Link ID field is contained in the transmission indication frame. One bit in this Link ID field corresponds to one affiliated AP of an AP MLD. For example, a bit at location i identifies the affiliated AP of the AP MLD operating over the link of which Link ID=i. If the Non-AP MLD wishes the AP MLD to use the AP2 to perform the transmission during the subsequent data transmission, then the Non-AP MLD would indicate this wish by setting the bit of the Link ID field that corresponds to the AP2. At the same time, the Non-AP MLD should also ensure that, the corresponding affiliated STA of the Non-AP MLD is able to receive data normally during the data transmission processes afterwards, otherwise the corresponding bit of the Link ID field is not set.

As illustrated in FIG. 19, the bit at location 2 of the Link ID field corresponds to the AP2. If the STA MLD intends to use the AP2 for the subsequent data transmission, then the bit at the location 2 of the Link ID field may be set as 1. In this way, it is indicated that, the AP MLD should also use the AP2 for downlink transmission in addition to the AP1. The bit at location 2 of the Link ID field may be set as 0, to indicate that the AP MLD would not use the AP2 for transmission afterwards.

Operation 3: the AP MLD wakes the affiliated AP2.

For the transmission of the group-addressed traffic, if the group-addressed traffic should be sent at this time, then the AP2 is waked directly. Then jump to the operation 4.

For the transmission of the individually-addressed traffic, in response to receiving the downlink transmission indication frame from the Non-AP MLD, the AP MLD may look up, based on the value in the transmitting-address field of the downlink transmission indication frame, the AID information of the Non-AP MLD. After the AID information is obtained, the AP MLD then knows which buffered traffic is required to use for response afterwards, as well as which links this traffic is mapped to. If this transmission indication frame is realized by wrapping a PS-Poll frame, then the AID information of the Non-AP MLD may be obtained directly through the ID field of the frame. Then the AP MLD may determine, based jointly on the link mapping information of the traffic buffered for the Non-AP MLD and the Link ID field of the transmission indication frame, which links to be used to transmit the downlink data. At the same time, the AP MLD replies with the Ack frame. If the traffic buffered for the Non-AP MLD is not mapped to the secondary link, then regardless how the Link ID field is set, the AP1 is used to transmit the downlink data. If the traffic buffered for the Non-AP MLD is mapped to the secondary link, then the Link ID field is checked to learn whether the Non-AP MLD has requested using the AP2. If the Non-AP MLD has requested using the AP2, then the AP2 is waked. When the AP2 is waked, the AP2 may also just be in the wake state, then the AP2 remains in the wake state until the end of the frame exchange sequence.

Operation 4: the AP1 performs the EDCA mechanism over the first link, and the AP2 performs the EDCA mechanism over the second link.

The AP1 performs the EDCA mechanism over the first link (the primary link), and the AP2 performs the EDCA mechanism over the second link (the secondary link). The backoff counter is decremented to zero. To ensure the synchronized transmission of the downlink data between the AP1 and the AP2, any one of the first AP and the second AP that backs off to zero first would keep its backoff counter at zero according to the multi-link channel access rule, and wait for another one of the first AP and the second AP to complete its backoff process before the synchronization transmission of the downlink data may be performed. If the AP2 is not used, then the AP1 would be used to transmit the downlink data.

After the frame exchange sequence is completed, the AP1, the AP2 (if participating in the transmission), the STA1, and the STA2 (if participating in the transmission) would return to sleeping state.

### Uplink Data Transmission Scenario

During an uplink transmission process, the affiliated STA1 of the Non-AP MLD transmits the transmission indication frame to the AP1 after contending for a TXOP over the link 1 (the primary link). This transmission indication frame is configured to indicate whether the AP2 should be waked. Afterwards the data transmission is performed.

### An Embodiment 5

For the sake of illustration, it is assumed that, the AP1 is always in the active state, the AP2 is always in the sleeping state, and the Non-AP MLD is always in the active state. This is the simplest combination of scenarios, but what states each of the AP1, the AP2, and the Non-AP MLD is in has no influence on the wake mechanism.

The AP MLD and the Non-AP MLD perform the following operations as illustrated in FIG. 20.

Operation 1: the Non-AP MLD transmits the uplink transmission indication frame to the AP MLD.

To transmit the uplink data, the Non-AP MLD first contends for the TXOP over the link 1 (the primary link) through the affiliated STA1. The STA1 transmits the uplink transmission indication frame to the AP1 before transmitting the uplink data. A Link ID field is included in this uplink transmission indication frame. One bit of this Link ID field corresponds to one affiliated AP value of an AP MLD. For example, a bit at location i identifies the affiliated AP of the AP MLD operating over the link of which Link ID=i. If the Non-AP MLD wishes the AP MLD to use the AP2 to perform the transmission during the subsequent data transmission, the Non-AP MLD would indicate this wish by setting the bit of the Link ID field that corresponds to the AP2. At the same time, the Non-AP MLD should also ensure that, the corresponding affiliated STA of the Non-AP MLD is able to receive data normally during the data transmission processes afterwards, otherwise the corresponding bit of the Link ID field is not set.

The bit at the location 2 of the Link ID field corresponds to the AP2. If the STA MLD intends to employ the AP2 for the subsequent data transmission, then the bit at the location 2 of the Link ID field may be set as 1. In this way, it is indicated that, the AP MLD should also employ the AP2 for reception of the uplink data in addition to the AP1. The bit at the location 2 of the Link ID field may be set as 0, to indicate that the AP MLD would not use the AP2 for transmission afterwards.

The uplink transmission indication frame uses the QoS-Null frame to achieve the uplink transmission indication frame.

The HT control field of the QoS-Null frame includes three variation fields such as HT, VHT and HE etc. The A-Control field of the HE variant is a control list that includes one or more control fields. Each control field is uniquely identified by a Control ID. In the current standard, values from 7 to 14 are reserved for the Control ID. Any of the reserved values may be used to identify the control fields designed in the present approach. The value used must not duplicate or be the same with the control ID of the control field of the uplink transmission indication frame. As illustrated in FIG. 21, the newly added control field provides the Link ID field that is configured to indicate the AP MLD to wake the affiliated AP. The Link ID field is a 4-bit field that identifies the affiliated AP of the AP MLD operating over a particular link. For example, a bit at the location i identifies the affiliated AP of the AP MLD operating over the link of which Link ID=i. Therefore, it is possible to set the bits of the Link ID field corresponding to the affiliated AP of the AP MLD operating over the secondary link, to indicate that, in addition to the affiliated AP operating over the primary link, which affiliated APs operating over the secondary link should be used by the AP MLD to receive the uplink data. For example, the bit at the location 1 of the Link ID field corresponds to the affiliated AP of the AP MLD operating over a link of which Link ID=1. Assuming that the link is a secondary link, thus the bit may be set as 1 to indicate the AP MLD to also use that AP for transmission when receiving the uplink data, and the bit may be set as 0 to indicate that this AP is not used for transmission.

In some embodiments of the present disclosure, as illustrated in FIG. 15, a structure of the control subfield of FIG. 13 may include: a Control identification (ID) subframe, a type subframe, and a Link identification (ID) subframe. The Type field identifies usage of the control field. If the Type subfield is set as 00, then it is identified that, the current frame is used for a wake indication of the AP2 in the case of the downlink transmission. If the Type subfield is set as 01, then it is identified that, the current frame is used for a wake indication of the AP2 in the case of the uplink transmission. This control field is included in the uplink transmission indication frame. According to the specific implementation of the uplink transmission indication frame of the implementation one, this Control field is included in the A-Control subfield of the HT Control field of a QoS-Null frame.

In some embodiments of the present disclosure, the non-link identification subfield in FIG. 13 and FIG. 15 may be replaced with the Link ID bitmap field. As compared to the Link ID field, the Link ID bitmap field includes more bits, and may indicate more affiliated APs operating over the secondary link.

Operation 2: The AP MLD transmits the Wrapped BA frame to the Non-AP MLD to indicate the wake result of the AP2.

In response to receiving the uplink transmission indication frame from the Non-AP MLD, the AP MLD checks the Link ID field of the uplink transmission indication frame, to determine whether the Non-AP MLD has requested to wake the AP2. The AP MLD considers, based on the request of the Non-AP MLD to wake the AP2 in the transmission indication frame and the actual condition, whether to wake the AP2, and at the same time, replies with the BlockAck frame wrapped using the Control Wrapper frame to the STA1. A Link ID field is further carried in the BlockAck frame. This Link ID field is configured to indicate the wake result to the Non-AP MLD. For example, the AP2 operates over a link of which Link ID=2. If the Non-AP MLD intends to use the AP2, then the bit at the location 2 of the Link ID field in the uplink transmission indication frame is set as 1. If the Non-AP MLD does not use the AP2, then this bit may be set as 0. The AP MLD replies with the Wrapped BA frame, indicating the wake result of the Non-AP MLD. Setting the bit at the location 2 of the Link ID field in the Wrapped BA as 1 indicates that, the AP2 has been waked, and setting the bit at the location 2 as 0 indicates that, the AP2 has not been waked. When the AP2 is waked, the AP2 may also just be in the wake state, then the AP2 remains in the wake state until the end of the frame exchange sequence.

A new Control Subfield carrying the indication message is defined in the Wrapped BA frame.

The Control Wrapper frame is used to wrap any other control frames, to provide more information through the wrapping process. Based on such an approach using the Control Wrapper, as illustrated in FIG. 21, the BlockAck frame may be wrapped by using the Control Wrapper frame. This is achieved by a way in which: the Carried Frame Control field of the Control Wrapper frame includes the Frame Control field of this BlockAck frame, and the Carried Frame field includes the fields subsequent to the Address 1 of the BlockAck frame, but the FCS field of the BlockAck frame is not included in the Carried Frame field. By using the A-Control field of the Control Wrapper, an additional indication message is provided. The A-Control field is a control list that includes one or more control fields. Each control field is uniquely identified by a Control ID. In the current standard, values from 11 to 14 are reserved for the Control ID. Any of the reserved values may be used to identify the control fields designed in the present approach. As illustrated in FIG. 21, the Indication subfield of the A-Control field contains a 4-bit Link ID subfield. The Link ID subfield indicates to the Non-AP MLD of the wake result of the affiliated APs operating over the secondary link. The corresponding bit being set as 1 indicates that, the corresponding AP has been waked. The corresponding bit being set as 0 indicates that, the AP2 has not been waked.

Here, the structure of the control subframe in FIG. 21 may be replaced with the control subframe illustrated in FIG. 15, and the link ID field in FIG. 21 and FIG. 15 may be replaced with a link ID bitmap field.

Operation 3: the Non-AP MLD transmits the uplink data to the AP MLD.

The Non-AP MLD determines, based on the indication message of the wrapped BlockAck frame replied by the AP MLD, whether to perform the transmission using one link or two links. If it is indicated in the wrapped BlockAck frame that the AP2 has been waked, then the STA1 and the STA2 may perform the synchronized transmission of the uplink data. The STA1 performs the EDCA mechanism over the first link (the primary link), the STA2 performs the EDCA mechanism over the second link (the secondary link), the backoff counters are decremented to zero. To ensure the synchronized transmission of the uplink data between the STA1 and the STA2, any one of the STA1 and the STA2 who has backed off to zero first would maintain its backoff counter at zero according to the multi-link channel access rule of the 802.11be, and wait for another of the STA1 and the STA2 to perform the synchronization transmission of the uplink data. After the frame exchange sequence is completed, the AP2 returns to the sleeping state. If it is indicated in the wrapped BlockAck frame that, the AP2 is not waked, then the STA1 transmits the uplink data after completing the backoff process over the link 1 (the primary link).

### An Embodiment 6

In the explicit wake mechanism, the energy-saving mode situation in which all three of the affiliated AP1 and the affiliated AP2 of the AP MLD, and the Non-AP MLD are considered. The AP1 may remain in the active state or in the energy-saving mode based on the implicit listening interval. The case in which the AP1 remains in the active state is the simplest case. The case where the AP1 is in the energy-saving mode based on the implicit listening interval is explained below. The AP2 may remain in the sleeping state or a certain energy-saving mode, such as the TWT, the WNM energy-saving mode and the baseline energy-saving mode. Whichever energy-saving mode the AP2 is in, the processes of the embodiments and the wake mechanism are not affected. In the latest 802.11be standard-Draft 1.1, the only energy-saving mode for the Non-AP MLD is the WNM energy-saving mode. In the WNM energy-saving mode, the sleeping states of various affiliated STAs of the Non-AP MLD are synchronized, i.e., the various affiliated STAs of the Non-AP MLD enter and wake from the sleeping state simultaneously. However, the standard also recites that, various affiliated STAs of the multi-link device may have independent energy-saving states and need not be synchronized. The independent energy-saving state is also more complex than the WNM. Therefore, in the embodiment 6, the affiliated STA of the Non-AP MLD is illustrated as being in an independent energy-saving state.

It is assumed that, the AP1 is in an energy-saving mode based on the implicit listening interval. The AP2 is in a certain energy-saving mode whose operating state consists of the wake state and the sleeping state. The affiliated STAs of the Non-AP MLD are in independent energy-saving states. In this mode, because the AP1 has an active listening interval, the AP1 would return to the sleeping state if it does not receive the downlink data transmission request or the uplink data transmission from the Non-AP MLD during the listening interval.

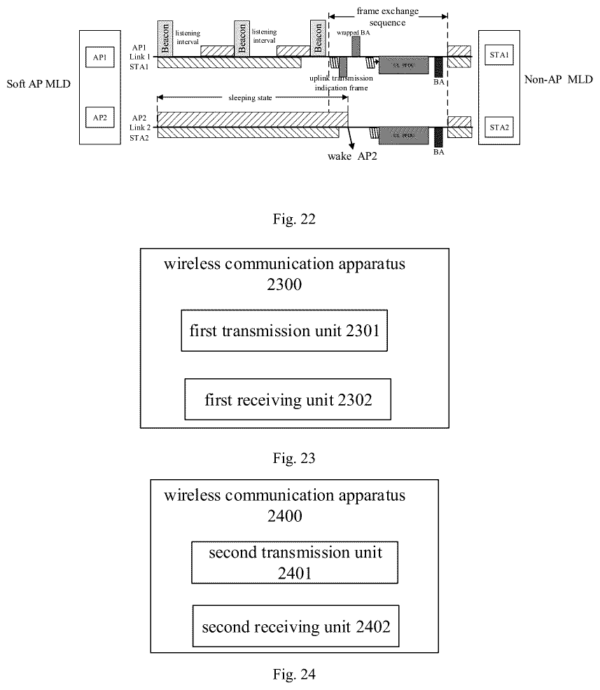

The AP MLD and the Non-AP MLD perform the following operations as illustrated in FIG. 22.

Operation 1: The Non-AP MLD transmits the uplink transmission indication frame to the AP MLD.

The AP1 is waked to transmit the Beacon frame at a predetermined time point for transmitting Beacon frames, after that, the AP1 actively listens for a time period of a listening interval. If there is no downlink data transmission request from the Non-AP MLD or no uplink transmission from the Non-AP MLD during this listening interval, then the AP1 returns to the sleeping state. The Non-AP MLD intends to transmit the uplink data, and waits for the STA1 to switch from the sleeping state to the active state. After being waked, the STA1 contends for the TXOP over the link 1 (the primary link), and transmits the uplink transmission indication frame during the listening interval of the AP1. A Link ID field is included in uplink transmission indication frame. One bit of the field corresponds to one affiliated AP value of an AP MLD. For example, a bit at location i identifies the affiliated AP of the AP MLD operating over the link of which Link ID=i. If the Non-AP MLD wishes the AP MLD to use the AP2 to perform the transmission during the subsequent data transmission, then the Non-AP MLD would indicate this wish by setting the bit of the Link ID field that corresponds to the AP2. At the same time, the Non-AP MLD should also ensure that, the corresponding affiliated STA of the Non-AP MLD is able to receive data normally during data transmission processes afterwards, otherwise the corresponding bit of the Link ID field is not set. For example, the bit at the location 2 of the Link ID field corresponds to the AP2. If the STA MLD intends to use the AP2 for the subsequent data transmission, then the bit at the location 2 of the Link ID field may be set as 1. In this way, it is indicated that, the AP MLD should also use the AP2 for reception of the uplink data in addition to the AP1. Or, the AP MLD should use both the AP1 and the AP2 for reception of the uplink data. The bit being set as 0 indicates that, the AP MLD would not use the AP2 afterwards.

Operation 2: the AP MLD transmits the Wrapped BA frame to the Non-AP MLD to indicate the wake result of the AP2.

In response to receiving the uplink transmission indication frame from the Non-AP MLD, the AP MLD checks the Link ID field of the uplink transmission indication frame, to determine whether the Non-AP MLD has requested to wake the AP2. The AP MLD considers, based on the request of the Non-AP MLD to wake the AP2 in the transmission indication frame and the actual condition, whether to wake the AP2. At the same time, the Non-AP MLD replies with the BlockAck frame wrapped using the Control Wrapper frame. A Link ID field is further carried in the BlockAck frame. This Link ID field is configured to indicate the wake result to the Non-AP MLD. For example, the AP2 operates over a link of which Link ID=2. If the Non-AP MLD intends to use the AP2, then the bit at the location 2 of the Link ID field in the transmission indication frame is set as 1. If the Non-AP MLD does not use the AP2, then this bit may be set as 0. Afterwards, the AP MLD replies with a Wrapped BA frame, indicating the wake result to the Non-AP MLD. Setting the bit at the location 2 of the Link ID field in the Wrapped BA as 1 indicates that, the AP2 has been waked, and setting the bit at the location 2 as 0 indicates that, the AP2 has not been waked. When the AP2 is waked, the AP2 may also just be in the wake state, then the AP2 remains in the wake state until the end of the frame exchange sequence.

Operation 3: the Non-AP MLD transmits the uplink data to the AP MLD. The Non-AP MLD determines, based on the indication message of the wrapped BlockAck frame replied by the AP MLD, whether to perform the transmission using one link or two links. If it is indicated in the wrapped BlockAck frame that the AP2 has been waked, then the STA1 and the STA2 perform the synchronized transmission of the uplink data. The STA1 performs the EDCA mechanism on the first link (the primary link), the STA2 performs the EDCA mechanism on the second link (the secondary link), and the backoff counters are decremented to zero. To ensure the synchronized transmission of the uplink data between the STA1 and the STA2, any one of the STA1 and the STA2 who has backed off to zero first would maintain its backoff counter at zero according to the multi-link channel access rule of the 802.11be, and wait for another one of the STA1 and the STA2 to perform the synchronization transmission of the uplink data. After the frame exchange sequence is completed, the AP1, the AP2, the STA1, and the STA2 returns to the sleeping state. If it is indicated in the wrapped BlockAck frame that the AP2 is not waked, then the STA1 transmits the uplink data after completing the backoff process over the link 1 (the primary link). After the frame exchange sequence is completed, the AP1 and the STA1 would return to the sleeping state.

The preferred embodiments of the present disclosure are described in detail above in conjunction with the accompanying drawings. However, the present disclosure is not limited to the specific details in the above-mentioned embodiments, and a variety of simple variations of the technical schemes of the present disclosure may be carried out within the technical conception scope of the present disclosure, and all these simple variations fall within the protecting scope of the present disclosure. For example, the various specific technical features described in the above Detailed Description part may be combined in any suitable manner without contradiction. To avoid unnecessary repetition, the various possible combinations are not separately described in the present disclosure. For another example, the various embodiments of the present disclosure may be combined in any way, and as long as they do not contradict the idea of the present disclosure, they should also be regarded as the contents disclosed in the present disclosure. For another example, under the premise of no conflict, the various embodiments described in the present disclosure and/or the technical features of the various embodiments may be combined with the prior art arbitrarily. The resulted technical scheme after the combination should also fall within the protection scope of the present disclosure.

It should further be appreciated that, in various method embodiments of the present disclosure, the order of the sequence numbers of the various processes described above does not imply the sequence of execution. The sequence of execution of the processes should be determined by their function and inherent logic, and should not constitute any limitation on the processes implemented in the embodiments of the present application. Furthermore, in some embodiments of the present disclosure, the terms “downlink”, “uplink”, and “sidelink” are used to indicate a transmission direction of the signal or data. The “downlink” is configured to indicate that the transmission direction of the signal or data is a first direction from the station to the user equipment of the cell. The “uplink” is configured to indicate that the transmission direction of the signal or data is a second direction from the user equipment of the cell to the station. The “sidelink” is configured to indicate that the transmission direction of the signal or data is a third direction from a user equipment 1 to a user equipment 2. For example, The “downlink signal” represents that the transmission direction of the signal is the first direction. In addition, in embodiments of the present disclosure, the term “and/or” is merely an associating relationship for describing the associated objects, and indicates that there could be three relationships between the associated objects. Specifically, A and/or B may represent three situations: only A exists; A and B exist simultaneously; or, only B exists. In the present disclosure, the character “/” generally indicates an “or” relationship between the associated objects before and after the character “/”.

FIG. 23 is a schematic structural composition diagram of a wireless communication apparatus applied to the AP MLD according to an embodiment of the present disclosure. As illustrated in FIG. 23, the wireless communication apparatus includes: a first transmission unit 2301 and/or a first receiving unit 2302.

The first transmission unit 2301 is configured to transmit, over the first link, the first message to the first station (STA) affiliated with the non-access point multi-link device (Non-AP MLD). The first message is configured to indicate whether the second AP affiliated with the AP MLD is in the wake state or the active state.

The first receiving unit 2302 is configured to receive, over the first link, the second message sent from the first STA affiliated with the Non-AP MLD. The second message is configured to request that the second AP affiliated with the AP MLD be in the wake state or the active state, or the second message is configured to indicate whether the second STA affiliated with the Non-AP MLD is in the wake state or the active state;

The first AP and the first STA are over the first link. The first link is the primary link. The second AP and the second STA are over the second link. The second link is the secondary link.

In some embodiments, the apparatus 2300 further includes a first control unit. The first control unit is configured to control the second AP to be in the wake state or the active state.

In some embodiments, the AP MLD controls the second AP to be in the wake state or the active state at the first time point. A location of the first time point is before the time point when the first AP transmits the first message or after the time point when the second message is received.

In some embodiments, the apparatus 2300 further includes a second control unit. When the location of the first time point is before the time point when the first AP transmits the first message, in a case where the second AP is in the wake state or the active state, the second control unit is configured to determine that the second AP has not received the second message within the first time duration, and the AP MLD controls the second AP to enter the sleeping state.

In some embodiments, the apparatus 2300 further includes a third control unit. When the location of the first time point is before the time point when the first AP transmits the first message, in a case where the second AP is in the wake state or the active state, the third control unit is configured to determine that the link used to transmit the pending traffic does not include the second link, and control the second AP to enter the sleeping state.

In some embodiments, the first message includes the first frame. The first frame is sent by the first AP in the case where the AP MLD buffers the pending traffic to be transmitted to the Non-AP MLD. The first frame is configured to indicate that, the link on which the pending traffic is mapped includes the second link.

In some embodiments, the second message includes the second frame received by the first AP from the first STA and/or the third frame received by the first AP from the first STA.

The second frame is configured to indicate that, the link used to transmit the pending traffic includes the second link. In response to the first STA receiving the first frame transmitted from the first AP, the first STA transmits the second frame to the first AP.

In response to the Non-AP MLD buffering the pending traffic to be transmitted to the AP MLD, the first STA transmits the third frame. The third frame is configured to indicate that, the link used to transmit the pending traffic includes the second link.

In some embodiments, the first frame carries the first indication message. The first indication message is configured to indicate that, the pending traffic is the downlink traffic to be transmitted to the Non-AP MLD.

In some embodiments, the first indication message is the first identifier. The first identifier taking the value of the first value is configured to indicate that, the pending traffic is the downlink traffic to be transmitted to the Non-AP MLD.

In some embodiments, the first identifier is a bit of the partial virtual bitmap of the first frame corresponding to the Non-AP MLD.

In some embodiments, the first frame carries the second indication message. The second indication message is configured to indicate that, the link on which the pending traffic is mapped includes the second link.

In some embodiments, the second indication message is the second identifier. The second identifier taking the second value is configured to indicate that, the link on which the pending traffic is mapped includes the second link.

In some embodiments, in the case where the addressing mode of the pending traffic is the group addressing, the second identifier is a bit of the delivery traffic indication map DTIM element.

In some embodiments, in the case where the addressing approach of the pending traffic is the individual addressing, the second identifier is a bit of the multi-link traffic element corresponding to the second link.

In some embodiments, the second frame carries the third indication message. The third indication message is configured to indicate that, the link used to transmit the pending traffic includes the second link.

In some embodiments, the third indication message is the third identifier. The third identifier taking the value of the third value is configured to indicate that, the link used to transmit the pending traffic includes the second link.

In some embodiments, in the case where the addressing mode of the pending traffic is the individual addressing, the third identifier is a bit of the second frame corresponding to the second link.

In some embodiments, the third indication message is carried in the first link field of the second frame. The first link field is the first control field or the second control field.

The first control field includes: a control identifier subfield and a data subfield including the third indication message. The second control field includes: a control identifier subfield, a type of subfield and a data subfield including the third indication message.

In some embodiments, the third frame carries the fourth indication message. The fourth indication message is configured to indicate that, the link used to transmit the pending traffic includes the second link.

In some embodiments, the fourth indication message is also configured to indicate that, the second STA is in the active state or the wake state.

In some embodiments, the fourth indication message is the fourth identifier. The fourth identifier taking the value of the fourth value is configured to indicate that, the link used to transmit the pending traffic includes the second link.

In some embodiments, the fourth identifier is a bit of the third frame corresponding to the second link.

In some embodiments, the fourth indication message is carried in the second link field of the third frame. The second link field is the third control field or the fourth control field.

The third control field includes: a control identifier subfield and a data subfield including the fourth indication message.

The fourth control field includes: a control identifier subfield, a type subfield and a data subfield including the fourth indication message.

In some embodiments, the apparatus 2300 further includes a first response unit. The first response unit is configured to: in response to the second message including the third frame, transmit the fourth frame to the first STA over the first link. The fourth frame is in in response to the third frame. The fourth frame is configured to indicate whether the second AP is in the wake state or the active state.

In some embodiments, the fourth frame carries the fifth indication message. The fifth indication message is configured to indicate whether the second AP is in the wake state or the active state.

In some embodiments, the fifth indication message is the fifth identifier. The fifth identifier taking the value of the fifth value is configured to indicate that, the second AP is in the wake state or the active state.

In some embodiments, the fifth identifier is a bit of the fourth frame corresponding to the second link.

In some embodiments, the fifth indication message is carried in the third link field of the fourth frame. The third link field is the fifth control field and/or the sixth control field.

The fifth control field includes: a control identifier subfield and a data subfield including the fifth indication message.

The sixth control field includes: a control identifier subfield, a type subfield and a data subfield including the fifth indication message.

In some embodiments, the data subfield includes at least one of: a link identifier field; and, a link identifier bitmap field.

In some embodiments, the apparatus 2300 further includes a first data transmission unit. The first data transmission unit is configured to: transmit the pending traffic to the Non-AP MLD over the first link and the second link; or receive the pending traffic from the Non-AP MLD over the first link and the second link.

In some embodiments, the apparatus 2300 further includes the third control unit. The third control unit is configured to: in response to the second AP being in the wake state or the active state, after the transmission of the pending traffic is completed, the AP MLD controls the second AP to enter the sleeping state.

In some embodiments, the operating mode of the AP MLD is independent from the operating mode of the Non-AP MLD.

In some embodiments, the operating mode of the AP MLD is the first operating mode. Under the first operating mode, the operating state of the second AP at least includes the sleeping state.

In some embodiments, under the first operating mode, the operating mode of the second AP is the first energy-saving mode. Under the first energy-saving mode, the operating state of the second AP is the sleeping state. In some embodiments, the operating state of the second AP under the first energy-saving mode includes: the sleeping state and the wake state.

In some embodiments, under the first operating mode, the operating mode of the first AP includes one of: the second energy-saving mode and the third energy-saving mode. In the second energy-saving mode, the operating state of the first AP under the second energy-saving mode is the active state. In the third energy-saving mode, the operating state of the first AP under the third energy-saving mode includes the sleeping state and the wake state.

In some embodiments, the operating mode of the Non-AP MLD is the second operating mode. Under the second operating mode, the operating mode of the first STA or the second STA affiliated with the Non-AP MLD includes one of: the fourth energy-saving mode and the fifth energy-saving mode. The operating state of the first AP or the second AP under the fourth energy-saving mode is the active state. The operating state of the first AP or the second AP under the fifth energy-saving mode includes the sleeping state and the wake state.

FIG. 24 is a schematic structural composition diagram of a wireless communication apparatus applied to the Non-AP MLD according to an embodiment of the present disclosure. As illustrated in FIG. 24, the wireless communication apparatus includes: a second receiving unit; and/or, a second transmission unit.

The second receiving unit is configured to: receive, over the first link, the first message sent from the first access point AP affiliated with the access point multi-link device AP MLD. The first message is configured to indicate whether the second AP affiliated with the AP MLD is in the wake state or the active state.

The second transmission unit is configured to: transmit the second message over the first link to the first AP affiliated with the AP MLD. The second message is configured to request that, the second AP affiliated with the AP MLD be in the wake state or the active state, or the second message is configured to indicate whether the second STA affiliated with the Non-AP MLD is in the wake state or the active state.

The first AP and the first STA are over the first link, and the first link is the primary link. The second AP and the second STA are over the second link, and the second link is the secondary link.

In some embodiments, the AP MLD controls the second AP to be in the wake state or the active state at the first time point. A location of the first time point is before the time point when the first AP transmits the first message or after the time point when the second message is received.

In some embodiments, the first message includes the first frame received by the first STA from the first AP. The first frame is sent by the first AP in the case where the AP MLD buffers the pending traffic to be transmitted to the Non-AP MLD. The first frame is configured to indicate that, the link on which the pending traffic is mapped includes the second link.

In some embodiments, the second message includes: the second frame sent by the first STA to the first SAP; and/or the third frame sent by the first STA to the first AP.

The second frame is configured to indicate that, the link used to transmit the pending traffic includes the second link. In response to the first STA receiving the first frame sent from the first AP, the first STA transmits the second frame to the first AP.

In response to the Non-AP MLD caching the pending traffic to be transmitted to the AP MLD, the first STA transmits the third frame. The third frame is configured to indicate that, the link used to transmit the pending traffic includes the second link.

In some embodiments, the first frame carries the first indication message. The first indication message is configured to indicate that, the pending traffic is the downlink traffic to be transmitted to the Non-AP MLD.

In some embodiments, the first indication message is the first identifier. The first identifier taking the value of the first value is configured to indicate that, the pending traffic is the downlink traffic to be transmitted to the Non-AP MLD.

In some embodiments, the first identifier is a bit of the partial virtual bitmap of the first frame corresponding to the Non-AP MLD.

In some embodiments, the first frame carries the second indication message. The second indication message is configured to indicate that, the link on which the pending traffic is mapped includes the second link.

In some embodiments, the second indication message is the second identifier. The second identifier taking the second value is configured to indicate that, the link on which the pending traffic is mapped includes the second link.

In some embodiments, in the case where the addressing mode of the pending traffic is group addressing, the second identifier is a bit of the delivery traffic indication map DTIM element.

In some embodiments, in the case where the addressing approach of the pending traffic is the individual addressing, the second identifier is a bit of the multi-link traffic element corresponding to the second link.

In some embodiments, the second frame carries the third indication message. The third indication message is configured to indicate that, the link used to transmit the pending traffic includes the second link.

In some embodiments, the third indication message is the third identifier. The third identifier taking the value of the third value is configured to indicate that, the link used to transmit the pending traffic includes the second link.

In some embodiments, in the case where the addressing approach of the pending traffic is the individual addressing, the third identifier is a bit of the second frame corresponding to the second link.

In some embodiments, the third indication message is carried in the first link field of the second frame. The first link field is the first control field or the second control field.

The first control field includes: a control identifier subfield and a data subfield including the third indication message.

The second control field includes: a control identifier subfield, a type subfield and a data subfield including the third indication message.

In some embodiments, the third frame carries the fourth indication message. The fourth indication message is configured to indicate that, the link used to transmit the pending traffic includes the second link.

In some embodiments, the fourth indication message is also configured to indicate the operating state of the second STA affiliated with the Non-AP MLD as the active state or the wake state.

In some embodiments, the fourth indication message is the fourth identifier. The fourth identifier taking the value of the fourth value is configured to indicate that, the link used to transmit the pending traffic includes the second link.

In some embodiments, the fourth identifier is a bit of the third frame corresponding to the second link.

In some embodiments, the fourth indication message is carried in the second link field of the third frame. The second link field is the third control field or the fourth control field.

The third control field includes: a control identifier subfield and a data subfield including the fourth indication message.

The fourth control field includes: a control identifier subfield, a type subfield and a data subfield including the fourth indication message.

In some embodiments, the apparatus 2400 further includes a second response unit. The second response unit is configured to: in response to the second message including the third frame, receive the fourth frame from the first AP over the first link. The fourth frame is in response to the third frame. The fourth frame is configured to indicate whether the second AP is in the wake state or the active state.

In some embodiments, the fourth frame carries the fifth indication message. The fifth indication message is configured to indicate whether the second AP is in the wake state or the active state.

In some embodiments, the fifth indication message is the fifth identifier. The fifth identifier taking the value of the fifth value is configured to indicate that, the second AP is in the wake state or the active state.

In some embodiments, the fifth identifier is a bit of the fourth frame corresponding to the second link.

In some embodiments, the fifth indication message is carried in the third link field of the fourth frame. The third link field is the fifth control field or the sixth control field.

The fifth control field includes: a control identifier subfield and a data subfield including the fifth indication message.

The sixth control field includes: a control identifier subfield, a type subfield and a data subfield including the fifth indication message.

In some embodiments, the data subfield includes at least one of: the link identifier field; and the link identifier bitmap field.

In some embodiments, the apparatus 2400 further includes a second data transmission unit. The second data transmission unit is configured to: receive the pending traffic from the AP MLD over the first link and the second link; or transmit the pending traffic to the AP MLD over the first link and the second link.

In some embodiments, after the transmission of the pending traffic is completed, the second AP switches from the wake state or the active state to the sleeping state.

In some embodiments, the operating mode of the AP MLD is independent from the operating mode of the Non-AP MLD.

In some embodiments, the operating mode of the AP MLD is the first operating mode. Under the first operating mode, the operating state of the second AP at least includes the sleeping state.

In some embodiments, under the first operating mode, the operating mode of the second AP is the first energy-saving mode. Under the first energy-saving mode, the operating state of the second AP is the sleeping state. In some embodiments, the operating state of the second AP under the first energy-saving mode includes: the sleeping state and the wake state.

In some embodiments, under the first operating mode, the operating mode of the first AP includes one of the following: the second energy-saving mode; and the third energy-saving mode.

The operating state of the first AP under the second energy-saving mode is the active state.

The operating state of the first AP under the third energy-saving mode includes the sleeping state and the wake state.

In some embodiments, the operating mode of the Non-AP MLD is the second operating mode. Under the second operating mode, the operating mode of the first STA or the second STA affiliated with the Non-AP MLD includes one of the following: the fourth energy-saving mode and the fifth energy-saving mode.

The operating state of the first AP or the second AP under the fourth energy-saving mode is the active state.

The operating state of the first AP or the second AP under the fifth energy-saving mode includes: the sleeping state and the wake state.

Those skilled in the art should understand that, the related description of the above-mentioned wireless communication apparatus in embodiments of the present disclosure may be referred to the related description of the wireless communication method in embodiments of the present disclosure for appreciation.

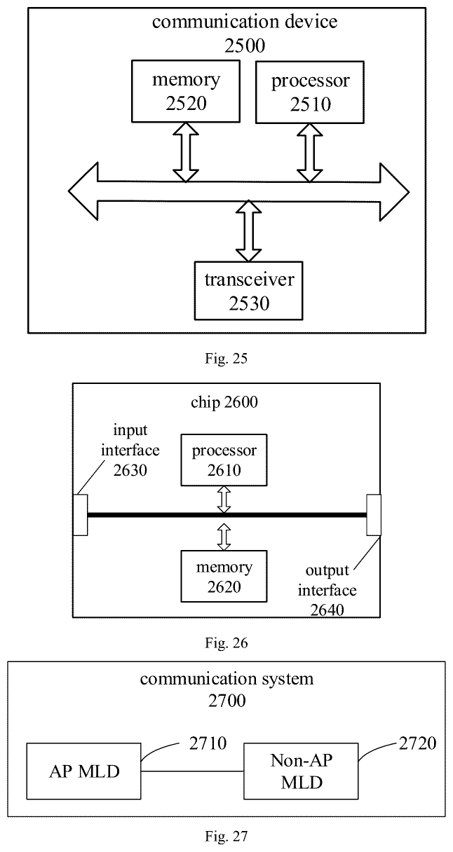

FIG. 25 is a schematic structural diagram of a communication device 2500 provided according to an embodiment of the present disclosure. The communication device may be an AP MLD, or a Non-AP MLD. The communication device 2500 as illustrated in FIG. 25 includes a processor 2510. The processor 2510 may be configured to call from a memory a computer program and run the same, thereby achieving the method according to embodiments of the present disclosure.

Alternatively, as illustrated in FIG. 25, the communication device 2500 may further include a memory 2520. The processor 2510 may call and execute the computer program from the memory 2520 to implement the methods in the embodiments of the present disclosure.

The memory 2520 may be a separate component from the processor 2510 or may be integrated in the processor 2510.

Alternatively, as illustrated in FIG. 25, the communication device 2500 may further include a transceiver 2530. The processor 2510 may control the transceiver 2530 to communicate with other devices, specifically, to transmit message or data to, or receive message or data from, other devices.

The transceiver 2530 may include a transmitter and a receiver. The transceiver 2530 may further include an antenna. The number of the antennas may be one or more.

Alternatively, the communication device 2500 may specifically be the AP MLD in embodiments of the present disclosure. The communication device 2500 may implement the corresponding processes implemented by the AP MLD in the various methods of embodiments of the present disclosure. For the sake of brevity, the details are not repeated here.

Alternatively, the communication device 2500 may specifically be the Non-AP MLD in embodiments of the present disclosure. The communication device 2500 may implement the corresponding processes implemented by the Non-AP MLD in the various methods of embodiments of the present disclosure. For the sake of brevity, the details are not repeated here.

FIG. 26 is a schematic structural diagram of a chip according to an embodiment of the present disclosure. The chip 2600 illustrated in FIG. 26 includes a processor 2610. The processor 2610 may call and execute a computer program from the memory to implement the methods in the embodiments of the present disclosure.

Alternatively, as illustrated in FIG. 26, the chip 2600 may further include a memory 2620. The processor 2610 may call and execute the computer program from the memory 2620 to implement the methods in the embodiments of the present disclosure.

The memory 2620 may be a separate component from the processor 2610 or may be integrated in the processor 2610.

Alternatively, the chip 2600 may further include an input interface 2630. The processor 2610 may control the input interface 2630 to communicate with other devices or chips, specifically, to obtain message or data sent from other devices or chips.

Alternatively, the chip 2600 may further include an output interface 2640. The processor 2610 may control the output interface 2640 to communicate with other devices or chips, specifically, to output message or data to other devices or chips.

Alternatively, the chip may be applied to the AP MLD in embodiments of the present disclosure, and the chip may implement the corresponding processes implemented by the AP MLD in the various methods of embodiments of the present disclosure. For the sake of brevity, the details are not repeated here.

Alternatively, the chip may be applied to the Non-AP MLD in embodiments of the present disclosure, and the chip may implement the corresponding processes implemented by the Non-AP MLD in the various methods of embodiments of the present disclosure. For the sake of brevity, the details are not repeated here.

The chip mentioned in embodiments of the present disclosure may also be referred to as a system-on-chip, a system-on-a-chip, a System on Chip or an SOC etc.

FIG. 27 is a schematic block diagram of a communication system 2700 according to an embodiment of the present disclosure. As illustrated in FIG. 27, the communication system 2700 includes the AP MLD 2710 and the Non-AP MLD 2720.

The AP MLD 2710 may be configured to implement the corresponding function of the above-mentioned method that is implemented by the AP MLD. The Non-AP MLD 2720 may be configured to implement the corresponding function of the above-mentioned method that is implemented by the Non-AP MLD. For the sake of brevity, the details are not repeated here.

It should be appreciated that, the processor of embodiments of the present disclosure may be a kind of integrated circuit chip, which is capable of processing signals. During implementation, each operation of the above-mentioned method embodiments may be accomplished by an integrated logic circuitry of a hardware of the processor or an instruction in software-form. The above-mentioned processor may be a general-purpose processor, a digital signal processor (DSP), an application specific integrated circuit (ASIC), a field programmable gate array (FPGA) or other programmable logic device, a discrete gate or a transistor logic device, a discrete hardware component. The processor may realize or implement various methods, steps or logical block diagrams disclosed in embodiments of the present disclosure. The general-purpose processor may be a micro-processor or the processor may also be any kind of conventional processor, etc. The steps of methods disclosed in conjunction with the embodiments of the present disclosure may be performed directly by the hardware decoding processor, or by a combination of hardware and software modules in the decoding processor. The software module may be located in a random memory, a flash memory, a read-only memory, a programmable read-only memory or an electrically erasable and programmable memory, a register and other storage media proven in the field. The storage medium is located in the memory. The processor may read the information in the memory and complete the steps of the above-mentioned method in combination with its hardware.

It should be appreciated that, the memory in some embodiments of the present disclosure may be a volatile memory or a non-volatile memory. The memory may include both the volatile memory and the non-volatile memory. The non-volatile memory may be a read-only memory (ROM), a programmable ROM (PROM), an erasable PROM (EPROM), an electrically EPROM (EEPROM) or a flash memory. The volatile memory may be a random access memory (RAM), which may be used as an external cache. By way of illustration but not limitation, many forms of RAMs are available, such as static RAMs (SRAM), dynamic RAMs (DRAM), synchronous DRAMs (SDRAM), double data rate SDRAMs (DDR SDRAM), enhanced SDRAMs (ESDRAM), synchlink DRAMs (SLDRAM), and direct rambus RAMs (DR RAM). It should be appreciated that, the memory of the systems and methods described herein is intended to include, but not limited to, these and any other suitable types of memories.

It should be appreciated that, the above-mentioned description of the memory is for illustration but not for limitation. For example, the memory in some embodiments of the present disclosure may further be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM) and a direct rambus RAM (DR RAM) etc. In other words, the memory described in embodiments of the present disclosure is intended to include, but is not limited to, these and any other suitable types of memories.

A computer-readable storage medium configured to store a computer program is provided in some embodiments of the present disclosure.

Alternatively, the computer-readable storage medium may be applied to the AP MLD in embodiments of the present disclosure, and the computer-readable storage medium enables the computer to implement the corresponding processes implemented by the AP MLD in the various methods of embodiments of the present disclosure. For the sake of brevity, the details are not repeated here.

Alternatively, the computer-readable storage medium may be applied to the Non-AP MLD in embodiments of the present disclosure, and the computer-readable storage medium enables the computer to implement the corresponding processes implemented by the Non-AP MLD in the various methods of embodiments of the present disclosure. For the sake of brevity, the details are not repeated here.

A computer program product including a computer program instruction is further provided according to some embodiments of the present disclosure.

Alternatively, the computer program instruction may be applied to the AP MLD in embodiments of the present disclosure, and the computer-readable storage medium enables the computer to implement the corresponding processes implemented by the AP MLD in the various methods of embodiments of the present disclosure. For the sake of brevity, the details are not repeated here.

Alternatively, the computer program instruction may be applied to the Non-AP MLD in embodiments of the present disclosure, and the computer-readable storage medium enables the computer to implement the corresponding processes implemented by the Non-AP MLD in the various methods of embodiments of the present disclosure. For the sake of brevity, the details are not repeated here.

A computer program is provided according to embodiments of the present disclosure.

Alternatively, the computer program may be applied to the AP MLD in embodiments of the present disclosure. The computer program, when running on the computer, enables the computer to implement the corresponding processes implemented by the AP MLD in the various methods of embodiments of the present disclosure. For the sake of brevity, the details are not repeated here.

Alternatively, the computer program may be applied to the Non-AP MLD in embodiments of the present disclosure, and the computer program, when running on the computer, enables the computer to implement the corresponding processes implemented by the Non-AP MLD in the various methods of embodiments of the present disclosure. For the sake of brevity, the details are not repeated here.

Those of ordinary skills in the art may realize that, the units and algorithmic steps of the various examples described in conjunction with the embodiments disclosed herein are capable of being implemented in electronic hardware, or a combination of computer software and electronic hardware. Whether these functions are performed in hardware or software depends on the specific application and design constraints of the technical schemes. For each particular application, a person skilled in the art may use different methods to implement the described functions, but such implementations should not be considered as beyond the scope of the present disclosure.

It is clear to those skilled in the art to which the present disclosure belongs that, for the sake of convenience and brevity, the specific operating processes of the above-described systems, apparatuses, and units may be referred to the corresponding processes in the foregoing method embodiments, and will not be elaborated herein.

In the embodiments provided in the present disclosure, the disclosed system, apparatus and method may be embodied in other ways. For example, the apparatus embodiments described above are merely illustrative. For example, the division of units is only a logical function division, and there may be other division manners in actual implementations. For example, multiple units or components may be combined or integrated into another system. Or some features may be ignored or not implemented. In addition, the illustrated or discussed mutual coupling or direct coupling or communicating connection may be indirect coupling or communicating connection through some interfaces, apparatuses, or units, and may be electrical, mechanical or of other forms.

The units illustrated as separate components may or may not be physically separate, and the components illustrated as units may or may not be physical units. The units may be located in one place or may be distributed on multiple network units. Some or all the units may be selected as per actual needs to fulfill the object of the implementation of the present embodiment.

In addition, each functional unit in embodiments of the present disclosure may be integrated into one processing unit, or may be physically separate units, or two or more units may be integrated into one unit.

If the function is implemented in the form of software functional units and sold or used as independent product, then they could be stored in a computer-readable storage medium. With this in mind, the technical solutions of the embodiments of the present disclosure in essence or its parts that contribute to the art or part of the technical scheme may be embodied in the form of a software product. The computer software product may be stored in a storage medium and include several instructions to make a computer device (which may be a personal computer, a server, or a network device etc.) to execute all or parts of the steps of the method described in various embodiments of the present disclosure. The afore-mentioned storage medium may include: a U disk, a mobile hard disk drive, a read only memory (ROM), a random access memory (RAM), a magnetic disk or a CD-ROM and other media that can store program codes.

The above are only specific implementations of the present disclosure, and the protection scope of the present disclosure is not limited thereto. Changes or alternations within the technical scope of the present disclosure could easily occur to those skilled in the art and should be in the protection scope of the present disclosure. Therefore, the protection scope of the present disclosure should be subject to the appended claims. cm What is claimed is:

1. A wireless communication method, comprising:
a first access point (AP) affiliated with an access point multi-link device (AP MLD) transmitting a first message over a first link to a first station (STA) affiliated with a non-access point multi-link device (Non-AP MLD), wherein the first message is configured to indicate whether a second AP affiliated with the AP MLD is in a wake state or an active state; and/or
the first AP affiliated with the AP MLD receiving, over the first link, a second message sent from the first STA affiliated with the Non-AP MLD, wherein the second message is configured to request the second AP affiliated with the AP MLD to be in the wake state or the active state, or the second message is configured to indicate whether a second STA affiliated with the Non-AP MLD is in the wake state or the active state;
wherein the first AP and the first STA are over the first link, the first link is a primary link, the second AP and the second STA are over a second link, and the second link is a secondary link.

2. The method as claimed in claim 1, wherein
the AP MLD controlling the second AP to be in the wake state or the active state at a first time point,
wherein a location of the first time point is before a time point when the first AP transmits the first message or after a time point when the second message is received.

3. The method as claimed in claim 2, wherein
in response to the location of the first time point being before the time point when the first AP transmits the first message, and in response to the second AP being in the wake state or the active state, the method further comprises:
the AP MLD determining that the second AP has not received the second message within a first time duration, and controlling the second AP to enter a sleeping state; and/or
the AP MLD determining that a link used to transmit a pending traffic does not include the second link, and controlling the second AP to enter a sleeping state.

4. The method as claimed in claim 1, wherein
the first message comprises a first frame, wherein the first frame is sent in response to a pending traffic to be transmitted to the Non-AP MLD being buffered in the AP MLD, and
the first frame is configured to indicate that, a link on which the pending traffic is mapped includes the second link.

5. The method as claimed in claim 4, wherein
the first frame carries a first indication message and/or a second indication message; and
the first indication message is configured to indicate that, the pending traffic is a downlink traffic to be transmitted to the Non-AP MLD, and
the second indication message is configured to indicate that, the link on which the pending traffic is mapped comprises the second link.

6. A access point multi-link device (AP MLD) comprising a processor and a memory, wherein
the memory is configured to store a computer program; and
the processor is configured to call and run the computer program stored in the memory, and perform a wireless communication method, the method comprises:
a first access point (AP) affiliated with the AP MLD transmitting a first message over a first link to a first station (STA) affiliated with a non-access point multi-link device (Non-AP MLD), wherein the first message is configured to indicate whether a second AP affiliated with the AP MLD is in a wake state or an active state; and/or
the first AP affiliated with the AP MLD receiving, over the first link, a second message sent from the first STA affiliated with the Non-AP MLD, wherein the second message is configured to request the second AP affiliated with the AP MLD to be in the wake state or the active state, or the second message is configured to indicate whether a second STA affiliated with the Non-AP MLD is in the wake state or the active state;
wherein the first AP and the first STA are over the first link, the first link is a primary link, the second AP and the second STA are over a second link, and the second link is a secondary link.

7. The AP MLD as claimed in claim 6, wherein
the AP MLD is configured to control the second AP to be in the wake state or the active state at a first time point,
wherein a location of the first time point is before a time point when the first AP transmits the first message or after a time point when the second message is received.

8. The AP MLD as claimed in claim 7, wherein
in response to the location of the first time point being before the time point when the first AP transmits the first message, and in response to the second AP being in the wake state or the active state, the method further comprises:
the AP MLD determining that the second AP has not received the second message within a first time duration, and controlling the second AP to enter a sleeping state; and/or
the AP MLD determining that a link used to transmit a pending traffic does not include the second link, and controlling the second AP to enter a sleeping state.

9. The AP MLD as claimed in claim 6, wherein
the first message comprises a first frame, wherein the first frame is sent in response to a pending traffic to be transmitted to the Non-AP MLD being buffered in the AP MLD, and
the first frame is configured to indicate that, a link on which the pending traffic is mapped includes the second link.

10. The AP MLD as claimed in claim 6, wherein
the second message comprises:
a second frame received by the first AP from the first STA, wherein the second frame is configured to indicate that, the link used to transmit the pending traffic comprises the second link, the first STA transmits, in response to receiving a first frame sent from the first AP, the second frame to the first AP; and/or
a third frame received by the first AP from the first STA, wherein the first STA transmits the third frame in response to a pending traffic to be transmitted to the AP MLD being buffered in the Non-AP MLD, the third frame is configured to indicate that, a link used to transmit the pending traffic comprises the second link.

11. The AP MLD as claimed in claim 9, wherein
the first frame carries a first indication message and/or a second indication message; and
the first indication message is configured to indicate that, the pending traffic is a downlink traffic to be transmitted to the Non-AP MLD, and
the second indication message is configured to indicate that, the link on which the pending traffic is mapped comprises the second link.

12. The AP MLD as claimed in claim 11, wherein
the first indication message is a first identifier; and
the first identifier taking a first value is configured to indicate that, the pending traffic is the downlink traffic to be transmitted to the Non-AP MLD; and/or
the second indication message is a second identifier; and
the second identifier taking a second value is configured to indicate that, the link on which the pending traffic is mapped comprises the second link.

13. The AP MLD as claimed in claim 12, wherein
the first identifier is a bit of a partial virtual bitmap of the first frame corresponding to the Non-AP MLD,
in response to an addressing mode of the pending traffic is group addressing, the second identifier is a bit of a delivery traffic indication map (DTIM) element, and/or
in response to the addressing mode of the pending traffic is individual addressing, the second identifier is a bit of a multi-link traffic element corresponding to the second link.

14. The AP MLD as claimed in claim 10, wherein
in response to the second message comprising the third frame, the method further comprises:
the first AP affiliated with the AP MLD transmitting a fourth frame over the first link to the first STA,
wherein the fourth frame is in response to the third frame, and the fourth frame is configured to indicate whether the second AP is in the wake state or the active state.

15. The AP MLD as claimed in claim 6, wherein
the AP MLD transmitting a pending traffic to the Non-AP MLD over the first link and the second link; or
the AP MLD receiving the pending traffic sent from the Non-AP MLD over the first link and the second link.

16. The AP MLD as claimed in claim 15, wherein
in response to the second AP being in the wake state or the active state, the method further comprises:
the AP MLD controlling, in response to transmission of the pending traffic being completed, the second AP to enter a sleeping state.

17. A non-access point multi-link device (Non-AP MLD) comprising a processor and a memory, wherein
the memory is configured to store a computer program; and
the processor is configured to call and run the computer program stored in the memory, and to perform a wireless communication method, the method comprises:
a first station (STA) affiliated with the Non-AP MLD receiving a first message transmitted by a first access point (AP) affiliated with an access point multi-link device (AP MLD) over a first link, wherein the first message is configured to indicate whether a second AP affiliated with the AP MLD is in a wake state or an active state; and/or
the first STA affiliated with the Non-AP MLD transmitting a second message over the first link to the first AP affiliated with the AP MLD, wherein the second message is configured to request that the second AP affiliated with the AP MLD to be in the wake state or the active state, or the second message is configured to indicate whether the second STA affiliated with the Non-AP MLD is in the wake state or the active state;
wherein the first AP and the first STA are over the first link, the first link is a primary link, the second AP and the second STA are over a second link, and the second link is a secondary link.

18. The Non-AP MLD as claimed in claim 17, wherein
the second message comprises:
a second frame sent by the first STA to the first SAP, wherein the second frame is configured to indicate that the link used to transmit the pending traffic comprises the second link, the first STA transmits, in response to receiving the first frame sent from the first AP, the second frame to the first AP; and/or
a third frame sent by the first STA to the first AP, wherein the first STA transmits the third frame in response to the pending traffic to be transmitted to the AP MLD being buffered in the Non-AP MLD, the third frame is configured to indicate that, the link used to transmit the pending traffic comprises the second link.

19. The Non-AP MLD as claimed in claim 18, wherein
the second frame carries a third indication message; and
the third indication message is configured to indicate that, the link used to transmit the pending traffic comprises the second link.

20. The Non-AP MLD as claimed in claim 18, wherein
the third frame carries a fourth indication message; and
the fourth indication message is configured to indicate that, the link used to transmit the pending traffic comprises the second link; and/or
the fourth indication message is further configured to indicate that, an operating state of the second STA affiliated with the Non-AP MLD is the active state or the wake state.
